(19) United States
(12) Patent Application Publication
(10) Pub. No.: US 2023/0137058 A1
(43) Pub. Date: May 4, 2023

(54) OPTIMIZED ROUTING APPLICATION FOR PROVIDING SERVICE TO AN AUTONOMOUS VEHICLE

(71) Applicant: TuSimple, Inc., San Diego, CA (US)

(72) Inventor: Joyce Tam, Pleasanton, CA (US)

(21) Appl. No.: 18/051,362

(22) Filed: Oct. 31, 2022

Related U.S. Application Data
(60) Provisional application No. 63/263,413, filed on Nov. 2, 2021.
(60) Provisional application No. 63/263,418, filed on Nov. 2, 2021.
(60) Provisional application No. 63/263,421, filed on Nov. 2, 2021.

(51) Int. Cl. B60W 60/00; B60W 50/14; B60W 30/18; G06Q 10/1093

(52) U.S. Cl. CPC B60W 60/001; B60W 50/14; B60W 30/181; G06Q 10/1095; B60W 2556/00

(57) ABSTRACT

A system includes an autonomous vehicle and an oversight server. The oversight server receives status data from the autonomous vehicle. The oversight server determines that a service is needed to be provided to the autonomous vehicle based on the status data. The oversight server determines an updated routing plan for the autonomous vehicle so that the service is provided to the autonomous vehicle. The oversight server communicates instructions that implement the updated routing plan to the autonomous vehicle.

### PRIORITY

This application claims priority to U.S. Provisional Patent Application No. 63/263,413 filed Nov. 2, 2021 and titled “Optimized Routing Application for Providing Service to an Autonomous Vehicle,” U.S. Provisional Patent Application No. 63/263,418 filed Nov. 2, 2021 and titled “Remote Access Application for an Autonomous Vehicle,” and U.S. Provisional Patent Application No. 63/263,421 filed Nov. 2, 2021 and titled “Periodic Mission Status Updates for an Autonomous Vehicle,” which are incorporated herein by reference.

### TECHNICAL FIELD

The present disclosure relates generally to autonomous vehicles. More particularly, the present disclosure is related to an optimized routing application for providing service to an autonomous vehicle.

### BACKGROUND

One aim of autonomous vehicle technologies is to provide vehicles that can safely navigate towards a destination. Similar to other vehicles, autonomous vehicles have components that may need to be serviced. In addition, autonomous vehicles have components that facilitate their autonomous operations. Sometimes, these components may need to be serviced to be fully operational. While in transit, the autonomous vehicle may need service to complete its trip. An autonomous vehicle is provided with a routing plan to reach a destination. Sometimes, the autonomous vehicle's routing plan may need to be updated to ensure safe operation of the autonomous vehicle, for example to accommodate servicing of the vehicle.

### SUMMARY

This disclosure recognizes various problems and previously unmet needs related to implementing safe navigation for an autonomous vehicle in situations where the autonomous vehicle needs service. Further, this disclosure recognizes various problems and previously unmet needs related to situations where a particular level and/or type of remote access to the autonomous vehicle is required. Further, this disclosure recognizes various problems and previously unmet needs related to situations where continuous or periodic confirmation, update, and/or override of a routing plan of an autonomous vehicle while the autonomous vehicle is in transit is required.

Some embodiments of this disclosure provide unique technical solutions to technical problems of autonomous vehicle technologies, including those problems described above to, at least, 1) update a routing plan of an autonomous vehicle so the autonomous vehicle receives a service; and 2) grant remote access to the autonomous vehicle; and 3) implement continuous or periodic confirmation, update, and/or override of a routing plan of an autonomous vehicle while the autonomous vehicle is in transit. These technical solutions are described below.

### Updating a Routing Plan so the Autonomous Vehicle Receives a Service

This disclosure contemplates systems and methods for updating a routing plan of an autonomous vehicle so the autonomous vehicle receives a service. In some cases, while the autonomous vehicle is in transit, one or more devices of the autonomous vehicle may determine that the autonomous vehicle needs a service, such as fueling, sensor calibration, refilling engine oil, refilling sensor cleaning fluid, and/or any other service that a vehicle may need. In such cases, the disclosed system(s) may determine whether the service can be provided to the autonomous vehicle on a side of a road, or whether the autonomous vehicle needs to travel to a service provider terminal to receive the service.

For example, the disclosed system may determine that the service can be provided to the autonomous vehicle on a side of a road, when it is determined that a service down time, while the autonomous vehicle is being serviced, is less than a threshold service downtime, e.g., less than ten minutes, twenty minutes, one hour, or any other suitable time period. Otherwise, the disclosed system may determine that the service cannot be provided to the autonomous vehicle on a side of a road.

If it is determined that the service can be provided to the autonomous vehicle on a side of a road, the disclosed system selects a particular service provider to provide the needed service to the autonomous vehicle on a side of the road. In this process, the disclosed system may send information about the needed service and a type of autonomous vehicle to one or more service providers within a threshold distance of the autonomous vehicle. The disclosed system may request the one or more service providers to provide a service quote, a service duration, one or more time slot options, and one or more location options for providing the service to the autonomous vehicle.

The disclosed system selects a particular service provider from among the one or more service providers to provide the needed service to the autonomous vehicle. The disclosed system may instruct the autonomous vehicle to meet the selected service provider at a particular location within a particular time window. The particular location is selected from the one or more location options received from the selected service provider. The particular time window is selected from one or more time slot options received from the selected service provider. The disclosed system may request the selected service provider to dispatch a service vehicle and a technician to provide the needed service to the autonomous vehicle at the particular location within the particular time window.

In selecting the particular service provider to provide the service to the autonomous vehicle, the disclosed system may select the particular service provider that would lead to optimizing one or more mission parameters. The mission parameters may include a route time completion, a fueling cost, a servicing cost, a cargo health, and a vehicle health. The route time completion may represent a time duration from when the autonomous vehicle starts its trip (e.g., a mission) from a start location (e.g., a launch pad) until it reaches a destination (e.g., a landing pad). The fueling cost may represent a cost of fuel that the autonomous vehicle would use to complete its trip that may include a cost of fuel that the autonomous vehicle would use to meet the selected service provider. The servicing cost may represent the cost of the needed service that the autonomous vehicle needs to complete a trip. The cargo health may represent the health of the cargo carried by the autonomous vehicle. The vehicle health may represent the health of components of the autonomous vehicle.

In case it is determined that the service cannot be provided on a side of a road, the disclosed system may select a particular service provider associated with a particular service provider terminal within a threshold distance of the autonomous vehicle so that the autonomous vehicle can receive the service at the particular service provider terminal.

The disclosed system may select the particular service provider from among one or more service providers within the threshold distance of the autonomous vehicle such that it leads to optimizing one or more of the mission parameters, similar to that described above.

When the disclosed system determines that the autonomous vehicle is autonomously operational, i.e., the autonomous vehicle can autonomously travel to the particular service provider terminal, the disclosed system instructs the autonomous vehicle to reroute to the particular service provider terminal. For example, the disclosed system may determine that the autonomous vehicle is autonomously operational when it is determined that the needed service is not related to autonomous functions and/or autonomously operating the autonomous vehicle is safe.

When the disclosed system determines that the autonomous vehicle is not autonomously operational, the disclosed system may instruct the autonomous vehicle to pull over.

When the disclosed system determines that the autonomous vehicle can be operated manually, the autonomous vehicle may request a service provider to dispatch a human driver to drive the autonomous vehicle to the particular service provider.

When the disclosed system determines that the autonomous vehicle cannot be operated manually, the autonomous vehicle may request the service provider to dispatch a towing vehicle to the autonomous vehicle's location to tow the autonomous vehicle to the particular service provider's terminal.

In this manner, the disclosed system may determine a more efficient way to provide the needed service to the autonomous vehicle compared to the current technology.

Accordingly, the disclosed system in this disclosure is integrated into a practical application of optimizing a routing plan of an autonomous vehicle to receive a service, optimizing the mission parameters, and/or improving the navigation of the autonomous vehicle that leads to a safer driving experience for the autonomous vehicle, other vehicles, and pedestrians.

Furthermore, the disclosed system may further be integrated into an additional practical application of enabling communication between the autonomous vehicle and servers associated with service providers. For example, the disclosed system may establish network communication with each server associated with each service provider for requesting to provide a service quote, a service duration, one or more time slot options, and one or more location options for providing the service to the autonomous vehicle.

According to one embodiment, a system comprises an autonomous vehicle and an oversight server. The autonomous vehicle is configured to travel along a road according to a routing plan, wherein the autonomous vehicle comprises at least one sensor. The oversight server is communicatively coupled with the autonomous vehicle. The oversight server comprises a processor configured to obtain status data, vehicle data, and autonomous vehicle health data captured by the at least one sensor. The processor may determine that a service is needed for the autonomous vehicle based at least in part upon the status data. The processor may determine an updated routing plan so that the service is provided to the autonomous vehicle. The processor may communicate instructions that implement the updated routing plan to the autonomous vehicle.

### Granting Remote Access to an Autonomous Vehicle

This disclosure also contemplates systems and methods for granting various types and/or levels of remote access to an autonomous vehicle depending on a situation. To this end, the disclosed system may determine whether one or more criteria apply to the autonomous vehicle. When the one or more criteria apply to the autonomous vehicle, the disclosed system may grant various types and/or levels of remote access to the autonomous vehicle depending on the situation.

The various types and/or levels of remote access may include allowing inbound data transmission to the autonomous vehicle (e.g., from a third party, an oversight server, etc.), allowing outbound data transmission from the autonomous vehicle (e.g., to a service provider, law enforcement, client, etc.), manual operation of one or more components of the autonomous vehicle (e.g., a door, a window, a radio device, etc.), manual operation of the autonomous vehicle, etc., as described below.

The one or more criteria may include a geofence area. For example, when the disclosed system determines that the autonomous vehicle is within a geofence area, the disclosed system may grant a particular access to the autonomous vehicle. For example, assume that the geofence area is associated with a place (e.g., a landing pad, a service provider terminal, etc.) and the autonomous vehicle is entering the geofence area. In this example, when the disclosed system determines that the autonomous vehicle has entered the geofence area, the disclosed system may remotely unlock doors of the autonomous vehicle.

The one or more criteria may include a particular time window. For example, when the disclosed system determines that the current time is within the particular time window and that the autonomous vehicle is operational, the disclosed system may grant a particular access to the autonomous vehicle. For example, assume that a software update package is scheduled to be transmitted to the autonomous vehicle during the particular time window. When the disclosed system determines that the current time is within the particular time window while the autonomous vehicle is in transit (or while the autonomous vehicle is not in transit, for example, at rest, at a terminal, at a launch pad, or at a landing pad), the disclosed system may transmit the software update package over-the-air to the autonomous vehicle.

The one or more criteria may include a credential received from a third party. The credential may include an identification card and/or a biometric feature associated with the third party.

For example, when the disclosed system determines that a credential associated with a third party who is requesting to access the autonomous vehicle is valid, the disclosed system may grant access to the autonomous vehicle.

In some embodiments, the disclosed system may determine whether multiple criteria apply to the autonomous vehicle. In an example scenario, assume that a third party (e.g., a service provider) approaches the autonomous vehicle to access the autonomous vehicle, e.g., to provide a service on a side of a road, similar to that described above. When the disclosed system determines that 1) both of the autonomous vehicle and the third party are in the geofence area; 2) the current time is within a particular time window; and 3) a credential received from the third party is valid, the disclosed system may grant a particular access to the autonomous vehicle. For example, the disclosed system may unlock a door of the autonomous vehicle, allow manual operation of the autonomous vehicle, allow access to certain information about the autonomous vehicle, such as health data, etc. Thus, in some scenarios, the criteria may act as a multi-factor authentication of a third party for determining that the third party is at the right place (e.g., in the geofence) at the right time (e.g., within the particular time window) and that the third party is authorized to access the autonomous vehicle by validating the credential of the third party.

Accordingly, the disclosed system in this disclosure is integrated into a practical application for granting various levels of remote access to an autonomous vehicle depending on a particular situation.

Furthermore, the disclosed system may further be integrated into an additional practical application of enabling communication between the autonomous vehicle and a device associated with a third party who is requesting to access the autonomous vehicle. For example, the disclosed system may receive a request from a device associated with third party to access the autonomous vehicle.

According to one embodiment, a system comprises an autonomous vehicle and an oversight server. The autonomous vehicle comprises at least one sensor configured to capture a first sensor data. The oversight server is communicatively coupled with the autonomous vehicle. The oversight server comprises a processor configured to obtain first sensor data from the autonomous vehicle. The processor may determine that one or more criteria apply to the autonomous vehicle based at least in part upon the first sensor data. The one or more criteria comprise at least one of a geofence area, a particular time window, and a credential received from a third party, where determining that the one or more criteria apply to the autonomous vehicle is based at least in part upon at least one of a location of the autonomous vehicle, a current time, and a credential received from a third party. The processor may grant remote access to the autonomous vehicle in response to determining that the one or more criteria apply to the autonomous vehicle.

### Implementing Continuous or Periodic Mission Status Updates for an Autonomous Vehicle

This disclosure contemplates systems and methods for implementing continuous or periodic mission status updates for an autonomous vehicle. For example, the disclosed system may periodically (e.g., every second, every few seconds, or any other time interval) update or confirm the mission status of the autonomous vehicle while the autonomous vehicle is in transit.

In some cases, while the autonomous vehicle is in transit, a routing plan of the autonomous vehicle may need to be changed due to an unexpected anomaly. For example, it may be determined that the autonomous vehicle needs a service. In another example, it may be determined that there is a severe weather event, a traffic event, or a road-block on a road ahead of the autonomous vehicle. Thus, by implementing continuous or periodic mission status updates for an autonomous vehicle, a routing plan of the autonomous vehicle can be updated based on a detected unexpected anomaly. The updated routing plan may be transmitted to the autonomous vehicle while the autonomous vehicle is autonomously traveling along a road. In other words, the updated routing plan may be transmitted to the autonomous vehicle without having to pull over the autonomous vehicle. The routing plan of the autonomous vehicle may be updated so that the mission parameters are optimized, similar to that described above.

Accordingly, the disclosed system in this disclosure is integrated into a practical application of implementing periodic mission status updates for an autonomous vehicle and communicating an updated routing plan to the autonomous vehicle while the autonomous vehicle is autonomously traveling along a road.

According to one embodiment, a system comprises one or more autonomous vehicles and an oversight server. Each of the one or more autonomous vehicles comprises at least one sensor. The oversight server is communicatively coupled with the one or more autonomous vehicles. The oversight server comprises a processor configured to obtain road condition data associated with the road ahead of the one or more autonomous vehicles. For an autonomous vehicle from among the one or more the autonomous vehicles, the processor obtains status data from the autonomous vehicle.

The oversight server's processor may determine that a routing plan associated with the autonomous vehicle should be updated based at least in part upon one or both of the road condition data and the status data, where determining that the routing plan should be updated is in response to detecting an unexpected anomaly in one or both of the road condition data and the status data that leads to diverting from the routing plan. The unexpected anomaly comprises one or more of: a severe weather event; a traffic event; a roadblock; and a service that needs to be provided to the autonomous vehicle. The processor may communicate the updated routing plan to the autonomous vehicle while the autonomous vehicle is autonomously driving along the road.

As such, the systems described in this disclosure may be integrated into practical applications for determining a more efficient, safe, and reliable navigation solution for autonomous vehicles as well as other vehicles on the same road as the autonomous vehicle.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for optimizing a routing plan for an autonomous vehicle to receive a service;

FIG. 2 illustrates an embodiment of a method for optimizing a routing plan for an autonomous vehicle to receive a service;

FIG. 3 illustrates an embodiment of a system for granting remote access to an autonomous vehicle;

FIG. 4 illustrates an embodiment of a method for granting remote access to an autonomous vehicle;

FIG. 5 illustrates a system for implementing periodic mission status updates for an autonomous vehicle;

FIG. 6 illustrates an embodiment of a method for implementing periodic mission status updates for an autonomous vehicle;

FIG. 7 illustrates a block diagram of an example autonomous vehicle configured to implement autonomous driving operations;

FIG. 8 illustrates an example system for providing autonomous driving operations used by the autonomous vehicle of FIG. 7; and

FIG. 9 illustrates a block diagram of an in-vehicle control computer included in the autonomous vehicle of FIG. 7.

### DETAILED DESCRIPTION

As described above, previous technologies fail to provide efficient, reliable, and safe navigation solutions for an autonomous vehicle in situations where the autonomous vehicle needs a service. Further, previous technologies fail to provide efficient, reliable, and safe solutions for an autonomous vehicle in situations where a particular level and/or type of remote access to the autonomous vehicle is required. Furthermore, previous technologies fail to provide efficient, reliable, and safe solutions to continuously or periodically confirm, update, and/or override a routing plan of an autonomous vehicle while the autonomous vehicle is in transit.

This disclosure provides various systems, methods, and devices to: 1) in case it is determined that the autonomous vehicle needs a service, determine an updated routing plan for the autonomous vehicle such that mission parameters are optimized, where the mission parameters include a route time completion, a fueling cost, a servicing cost, a cargo health, and a vehicle health; 2) determine that one or more criteria apply to an autonomous vehicle, and grant various levels and/or types of remote access to the autonomous vehicle depending on a situation, where the various levels and/or types of remote access may include allowing inbound data transmission to the autonomous vehicle (e.g., from a third party, an oversight server, etc.), allowing outbound data transmission from the autonomous vehicle (e.g., to a service provider, law enforcement, client, etc.), manual operation of one or more components of the autonomous vehicle (e.g., a door, a window, a radio device, etc.), manual operation of the autonomous vehicle, among others; 3) continuously or periodically confirm, update, and/or override a routing plan of the autonomous vehicle based on road condition and status data associated with the autonomous vehicle while the autonomous vehicle is autonomously traveling along a road such that the mission parameters are optimized; 4) obtain pre-trip (and post-trip) inspection information by analyzing sensor data captured from an autonomous vehicle's sensors and supply the pre-trip (and post-trip) inspection information to a third party; and 5) provide a safe driving experience for autonomous vehicles, other vehicles, and pedestrians.

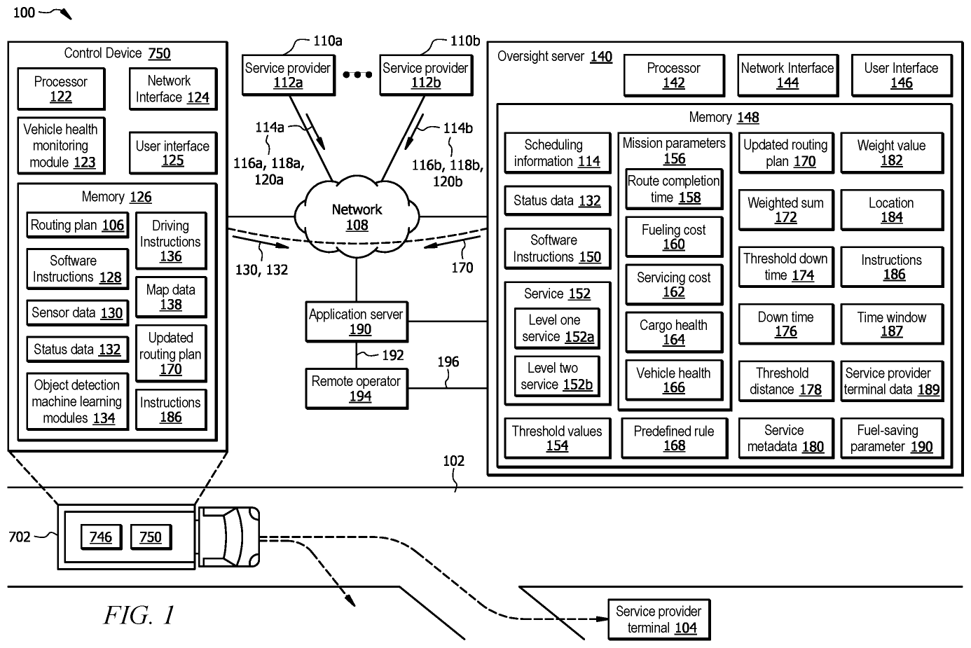

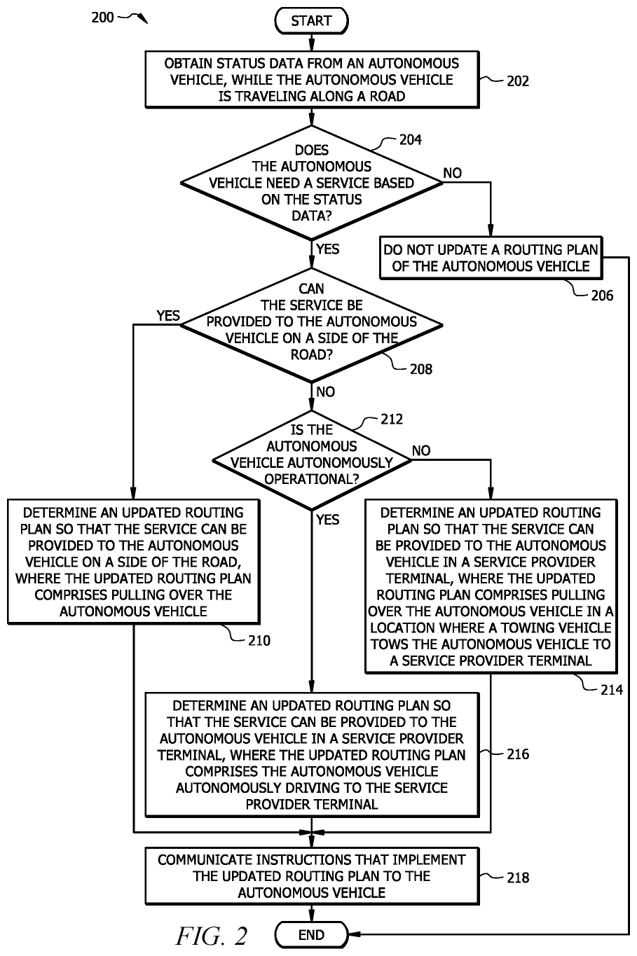

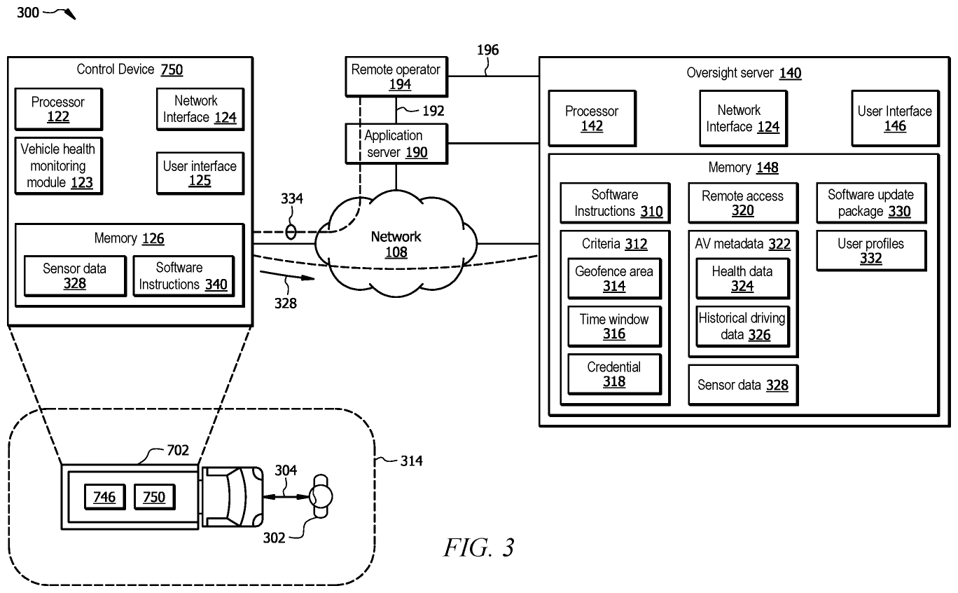

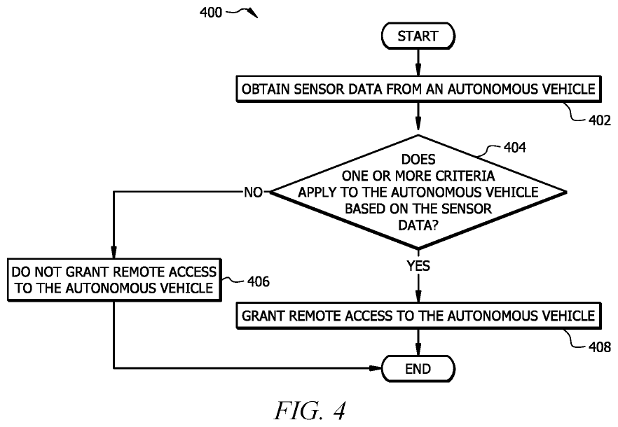

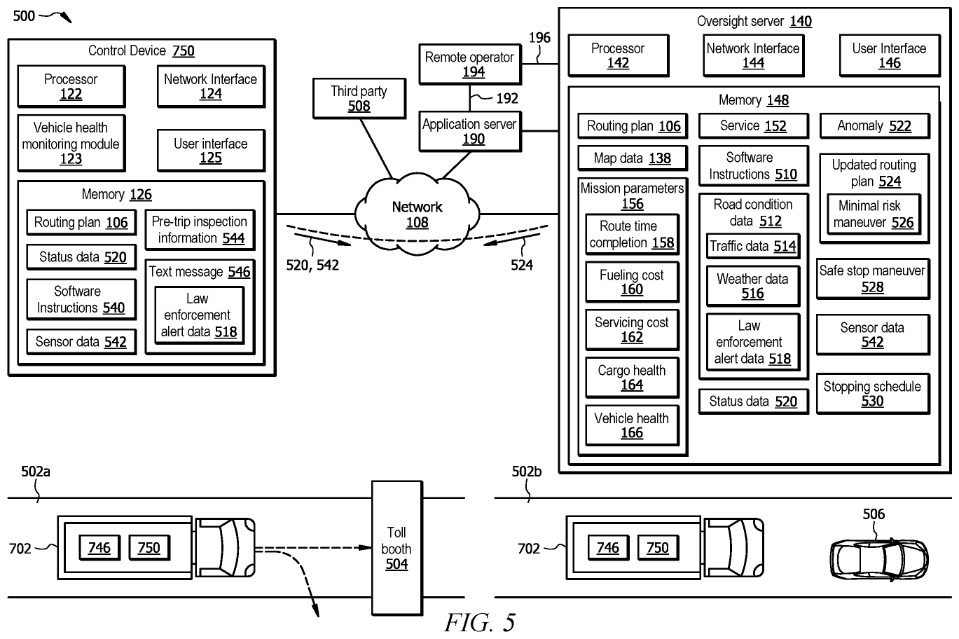

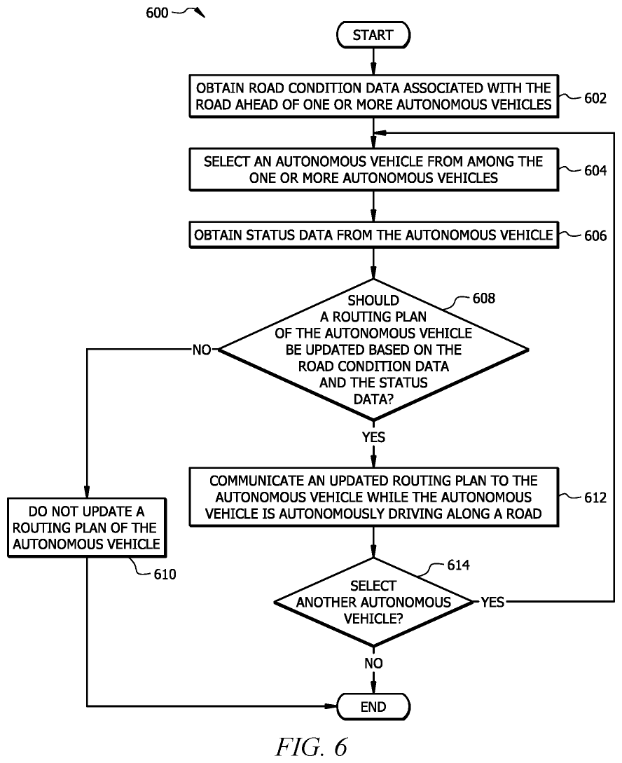

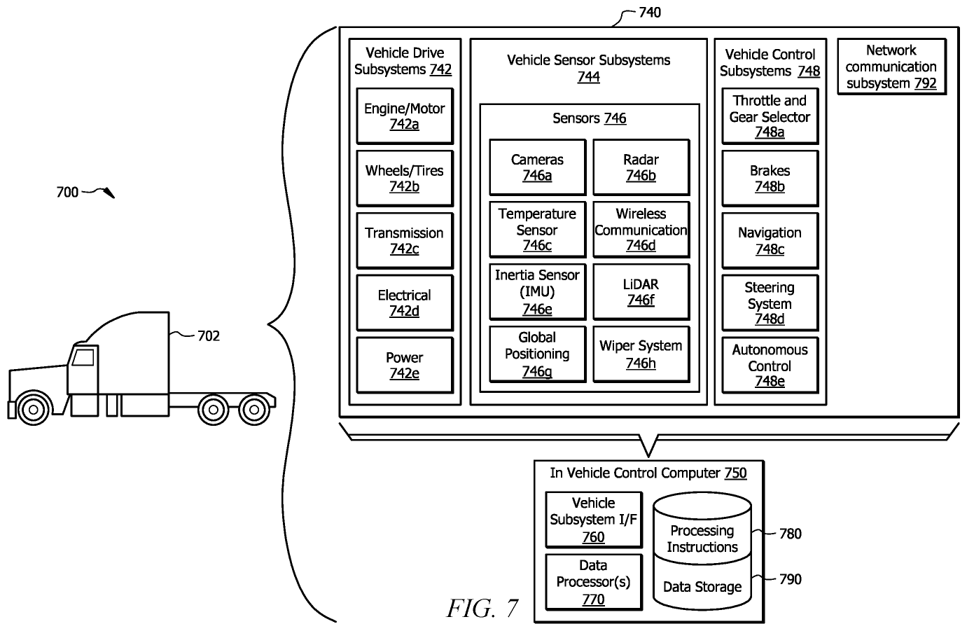

FIG. 1 illustrates an embodiment of a system 100 for optimizing a routing plan for an autonomous vehicle to receive a service. FIG. 2 illustrates an embodiment of a method 200 for optimizing a routing plan for an autonomous vehicle to receive a service. FIG. 3 illustrates an embodiment of a system 300 for granting remote access to an autonomous vehicle. FIG. 4 illustrates an embodiment of a method 400 for granting remote access to an autonomous vehicle. FIG. 5 illustrates a system 500 for implementing periodic mission status updates for an autonomous vehicle. FIG. 6 illustrates an embodiment of a method 600 for implementing periodic mission status updates for an autonomous vehicle. FIGS. 7-9 illustrate an example autonomous vehicle and its various systems and devices for implementing autonomous driving operations by the autonomous vehicle.

### Example System for Optimizing a Routing Plan for an Autonomous Vehicle to Receive a Service

FIG. 1 illustrates an embodiment of a system 100 configured for optimizing a routing plan 106 of an autonomous vehicle 702 to receive a service 152. FIG. 1 further illustrates a simplified schematic diagram of a road 102 traveled by the autonomous vehicle 702. In one embodiment, system 100 comprises an autonomous vehicle 702 and an oversight server 140. In some embodiments, system 100 further comprises a network 108, one or more service providers 112, an application server 190, and a remote operator 194. Network 108 enables communications between components of the system 100. Oversight server 140 comprises a processor 142 in signal communication with a memory 148. Memory 148 stores software instructions 150 that, when executed by the processor 142, cause the oversight server 140 to execute one or more functions described herein. For example, when the software instructions 150 are executed, the oversight server 140 may determine whether the autonomous vehicle 702 needs a service 152, and when it is determined that the autonomous vehicle 702 needs a service 152, the oversight server 140 determines an updated routing plan for the autonomous vehicle so that the service 152 is provided to the autonomous vehicle 702. The autonomous vehicle 702 comprises a control device 750. The control device 750 comprises a processor 122 in signal communication with a memory 126. Memory 126 stores software instructions 128 that when executed by the processor 122 cause the control device 750 to perform one or more functions described herein. For example, when the software instructions 128 are executed, the control device 750 may execute instructions 186 to implement an updated routing plan 170 for the autonomous vehicle 702 so that the autonomous vehicle 702 can receive a needed service 152. System 100 may be configured as shown or in any other configuration.

In general, the system 100 may be configured to optimize a routing plan 106 of the autonomous vehicle 702 when it is determined that the autonomous vehicle 702 needs a service 152 while the autonomous vehicle 702 is in transit. In some cases, while the autonomous vehicle 702 is in transit, it may be determined that the autonomous vehicle 702 needs a service 152. The service 152 may include fueling, cleaning one or more sensors 746, adding to a cleaning fluid reservoir used for cleaning the sensors 746, adding oil to an engine/motor 742a (see FIG. 7), changing the oil of the engine/motor 742a (see FIG. 7), changing a tire, filling a tire with air, and/or any other service 152 that may be related to any component of the autonomous vehicle 702. The service 152 may be related to an autonomous function of the autonomous vehicle 702 and/or a non-autonomous function of the autonomous vehicle 702. The system 100 may optimize the routing plan 106 of the autonomous vehicle 702 by determining an updated routing plan 170 such that a predefined rule 168 is met. The predefined rule 168 may be defined to optimize one or more mission parameters 156. The one or more mission parameters 156 may comprise a route completion time 158, a fueling cost 160, a servicing cost 162, a cargo health 164, and a vehicle health 166 (also referred to herein as an autonomous vehicle health). The system 100 may determine that the autonomous vehicle 702 needs a service 152 based on one or more threshold values 154 associated with the one or more mission parameters 156. Details of operations of the system 100 are described further below in conjunction with an operational flow of the system 100.

### System Components

### Example Autonomous Vehicle

In one embodiment, the autonomous vehicle 702 may include a semi-truck tractor unit attached to a trailer 704 to transport cargo or freight from one location to another location (see FIG. 7). The autonomous vehicle 702 is generally configured to travel along a road 102 in an autonomous mode. The autonomous vehicle 702 may navigate using a plurality of components described in detail in FIGS. 7-9. The operation of the autonomous vehicle 702 is described in greater detail in FIGS. 7-9. The corresponding description below includes brief descriptions of some components of the autonomous vehicle 702.

Control device 750 may be generally configured to control the operation of the autonomous vehicle 702 and its components and to facilitate autonomous driving of the autonomous vehicle 702. The control device 750 may be further configured to determine a pathway in front of the autonomous vehicle 702 that is safe to travel and free of objects or obstacles, and navigate the autonomous vehicle 702 to travel in that pathway. This process is described in more detail in FIGS. 7-9. The control device 750 may generally include one or more computing devices in signal communication with other components of the autonomous vehicle 702 (see FIG. 7). In this disclosure, the control device 750 may interchangeably be referred to as an in-vehicle control computer 750 as shown in FIG. 7.

As shown in FIG. 1, the control device 750 may be configured to detect objects on and around road 102 by analyzing the sensor data 130 and/or map data 138. For example, the control device 750 may detect objects on and around road 102 by implementing object detection machine learning modules 134. The object detection machine learning modules 134 may be implemented using neural networks and/or machine learning algorithms for detecting objects from images, videos, infrared images, point clouds, radar data, etc. The object detection machine learning modules 134 are described in more detail further below. The control device 750 receives sensor data 130 from the sensors 746 positioned on the autonomous vehicle 702 to determine a safe pathway to travel. The sensor data 130 may include data captured by the sensors 746.

Sensors 746 are configured to capture any object within their detection zones or fields of view, such as landmarks, lane markings, lane boundaries, road boundaries, vehicles, pedestrians, road/traffic signs, among others. The sensors 746 may include cameras, LiDAR sensors, motion sensors, infrared sensors, and the like. In one embodiment, the sensors 746 may be positioned around the autonomous vehicle 702 (e.g., positioned on the trailer 704 and/or tractor of the autonomous vehicle 702) to capture the environment surrounding the autonomous vehicle 702. In some embodiments, one or more sensors 746 may be positioned on and/or inside the tractor and/or the trailer 704 of the autonomous vehicle 702, where the sensors 746 may provide information about the trailer 704 to the control device 750. Thus, in some embodiments, the trailer 704 may be a “smart trailer” 704 that can provide information about the trailer 704 to the control device 750 via the sensors 746 associated with the trailer 704. See the corresponding description of FIG. 7 for further description of the sensors 746.

### Network

Network 108, as shown in FIG. 1, may be any suitable type of wireless and/or wired network, including all or a portion of the Internet, an Intranet, a private network, a public network, a peer-to-peer network, the public switched telephone network, a cellular network, a local area network (LAN), a metropolitan area network (MAN), a wide area network (WAN), and/or a satellite network. The network 108 may be configured to support any suitable type of communication protocol as would be appreciated by one of ordinary skill in the art.

### Service Provider

Each of the service providers 112 may be associated with a server 110. Each of the servers 110a and 110b is an instance of a server 110. The server 110 is generally a device that is configured to process data and communicate with computing devices (e.g., the oversight server 140), etc., via the network 108. Each server 110 may comprise a processor (not shown) in signal communication with a memory (not shown) to perform one or more functions of the server 110 described herein. For example, a software application designed using software code may be stored in the memory of the server 110 and executed by the processor of the server 110 to perform the functions of the server 110.

Each service provider 112 may be associated with one or more services 152. For example, each of the service providers 112a and 112b may be associated with (e.g., known to provide) fueling, tire servicing, oil serving, and/or any other services 152. Each service provider 112 may be associated with providing one or more services 152 to one or more particular types of autonomous vehicles 702. For example, the service provider 112a may be associated with providing one or more services 152 to sedans and semi-trailer trucks, while the service provider 112b may be associated with providing one or more services 152 to semi-trailer trucks. Each service provider 112 may be associated with one or more vehicles to dispatch to provide a service 152 to an autonomous vehicle 702 and/or other vehicles on a side of a road 102. Each service provider 112 may be associated with one or more terminals 104 to provide services 152 to autonomous vehicles 702 and/or other vehicles. Each service provider 112 may be associated with one or more towing vehicles to dispatch to an autonomous vehicle 702 so that they can tow the autonomous vehicle 702 to a terminal 104 associated with the service provider 112.

When oversight server 140 determines that a service 152 is needed for an autonomous vehicle 702, the oversight server 140 sends a request to one or more service providers 112 (e.g., to one or more servers 110 associated with one or more service providers 112) to provide scheduling information 114 to provide the service 152 to the autonomous vehicle 702. The oversight server 140 may receive one or more scheduling information 114 from one or more service providers 112. The oversight server 140 uses the received scheduling information 114 to select a particular service provider 112 from among one or more service providers 112 to provide the needed service 152 to the autonomous vehicle 702. This operation is described further below in conjunction with the operational flow of the system 100.

### Control Device

The control device 750 is described in detail in FIG. 7. In brief, the control device 750 may include a processor 122 in signal communication with a vehicle health monitoring module 123, a network interface 124, a user interface 125, and a memory 126. The processor 122 may include one or more processing units that perform various functions as described herein. The components of the control device 750 are operably coupled to each other. The memory 126 stores any data and/or instructions used by the processor 122 to perform its functions. For example, the memory 126 stores software instructions 128 that when executed by the processor 122 cause the control device 750 to perform one or more functions described herein.

The processor 122 may be one of the data processors 770 described in FIG. 7. The processor 122 comprises one or more processors operably coupled to the memory 126. The processor 122 may include electronic circuitry, including state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 may be communicatively coupled to and in signal communication with the network interface 124 and memory 126. The one or more processors are configured to process data and may be implemented in hardware or software. For example, the processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 128 to implement the functions disclosed herein, such as some or all of those described with respect to FIGS. 1-9. In some embodiments, the functions described herein may be implemented using logic units, FPGAs, ASICs, DSPs, or any other suitable hardware or electronic circuitry.

Vehicle health monitoring module 123 may be implemented in hardware and/or software modules, and is generally configured to keep records of status data 132 that includes health and status of components of the autonomous vehicle 702. The vehicle health monitoring module 123 may be operably coupled to sensors 746 and other sensors that are configured to determine heath and status of the components of the autonomous vehicle 702. For example, the vehicle health monitoring module 123 may be coupled to sensors that are configured to measure a fuel level, an oil level, tire pressures, engine temperature, cargo health, vehicle health, battery levels, electrical circuits, communication capacity, and the like. In some examples, the status data 132 may include health data associated with one or more components of the autonomous vehicle 702, a fuel level, an oil level, a level of a cleaning fluid used for cleaning at least one sensor 746, a cargo health, a location of the autonomous vehicle 702, a traveled distance from a start location (e.g., a launch pad), and a remaining distance to reach a destination (e.g., a landing pad).

The network interface 124 may be a component of the network communication subsystem 792 described in FIG. 7. The network interface 124 may be configured to enable wired and/or wireless communications. The network interface 124 may be configured to communicate data between the control device 750 and other network devices, systems, or domain(s). For example, the network interface 124 may comprise a WIFI interface, a local area network (LAN) interface, a wide area network (WAN) interface, a modem, a switch, or a router. The processor 122 may be configured to send and receive data using the network interface 124. The network interface 124 may be configured to use any suitable type of communication protocol.

User interface 125 may include one or more user interfaces that are configured to interact with a user who is determined to be authorized to access data associated with the autonomous vehicle 702, such as data that is available in the memory 126. In one embodiment the user interface 125 may include a human-machine interface module that comprises a display screen, a camera, a microphone, a speaker, a keyboard, a mouse, a trackpad, a touchpad, etc. The control device 750 may be configured to display data associated with the autonomous vehicle 702 on the display screen included in the user interface 125. In one embodiment, an instance of the user interface 125 may be located in a compartment that is accessible from outside of the autonomous vehicle 702. For example, the user interface 125 may include a human-machine interface module that is accessible from outside of the semi-truck tractor unit (i.e., cab) of the autonomous vehicle 702. In one embodiment, an instance of the user interface 125 may be located inside of the autonomous vehicle 702. For example, the user interface 125 may include a human-machine interface module that is accessible from within the cab of the autonomous vehicle 702.

The memory 126 may be one of the data storage units or devices 790 described in FIG. 7. The memory 126 stores any of the information described in FIGS. 1-9 along with any other data, instructions, logic, rules, or code operable to implement the function(s) described herein when executed by processor 122. For example, the memory 126 may store software instructions 128, sensor data 130, status data 132, routing plan 106, object detection machine learning modules 134, driving instructions 136, map data 138, updated routing plan 170, instructions 186, and/or any other data/instructions. The software instructions 128 include code that when executed by the processor 122 causes the control device 750 to perform the functions described herein, such as some or all of those described in FIGS. 1-9. The memory 126 comprises one or more disks, tape drives, or solid-state drives, and may be used as an over-flow data storage device, to store programs when such programs are selected for execution, and to store instructions and data that are read during program execution. The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc.

Routing plan 106 may include a plan for traveling from a start location (e.g., a first autonomous vehicle launchpad/landing pad) to a destination (e.g., a second autonomous vehicle launchpad/landing pad). For example, the routing plan 106 may specify a combination of one or more streets, roads, and highways in a specific order from the start location to the destination. The routing plan 106 may specify stages, including the first stage (e.g., moving out from a start location/launch pad), a plurality of intermediate stages (e.g., traveling along particular lanes of one or more particular street/road/highway), and the last stage (e.g., entering the destination/landing pad). The routing plan 106 may include other information about the route from the start position to the destination, such as road/traffic signs along the route in that routing plan 106, estimated travel distance when fully fueled, refueling station locations, areas where weigh-ins or tolls may be required, and other factors that may influence the time or distance traveled by an autonomous vehicle following the routing plan 106.

Object detection machine learning modules 134 may be implemented by the processor 122 executing software instructions 128, and may be generally configured to detect objects and obstacles from the sensor data 130. The object detection machine learning modules 134 may be implemented using neural networks and/or machine learning algorithms for detecting objects from any data type, such as images, videos, infrared images, point clouds, radar data, audio, ultrasonic sensor data, wind sensor data, atmospheric pressure data, and the like.

In one embodiment, the object detection machine learning modules 134 may be implemented using machine learning algorithms, such as support vector machine (SVM), Naive Bayes, Logistic Regression, k-Nearest Neighbors, Decision Trees, or the like. In one embodiment, the object detection machine learning modules 134 may utilize a plurality of neural network layers, convolutional neural network layers, and/or the like, in which weights and biases of these layers are optimized in the training process of the object detection machine learning modules 134. The object detection machine learning modules 134 may be trained by a training dataset that includes samples of data types labeled with one or more objects in each sample. For example, the training dataset may include sample images of objects (e.g., vehicles, lane markings, pedestrians, road signs, obstacles, etc.) labeled with object(s) in each sample image. Similarly, the training dataset may include samples of other data types, such as videos, infrared images, point clouds, radar data, etc. labeled with object(s) in each sample data. The object detection machine learning modules 134 may be trained, tested, and refined by the training dataset and the sensor data 130. The object detection machine learning modules 134 use the sensor data 130 (which are not labeled with objects) to increase their accuracy of predictions in detecting objects. For example, supervised and/or unsupervised machine learning algorithms may be used to validate the predictions of the object detection machine learning modules 134 in detecting objects in the sensor data 130.

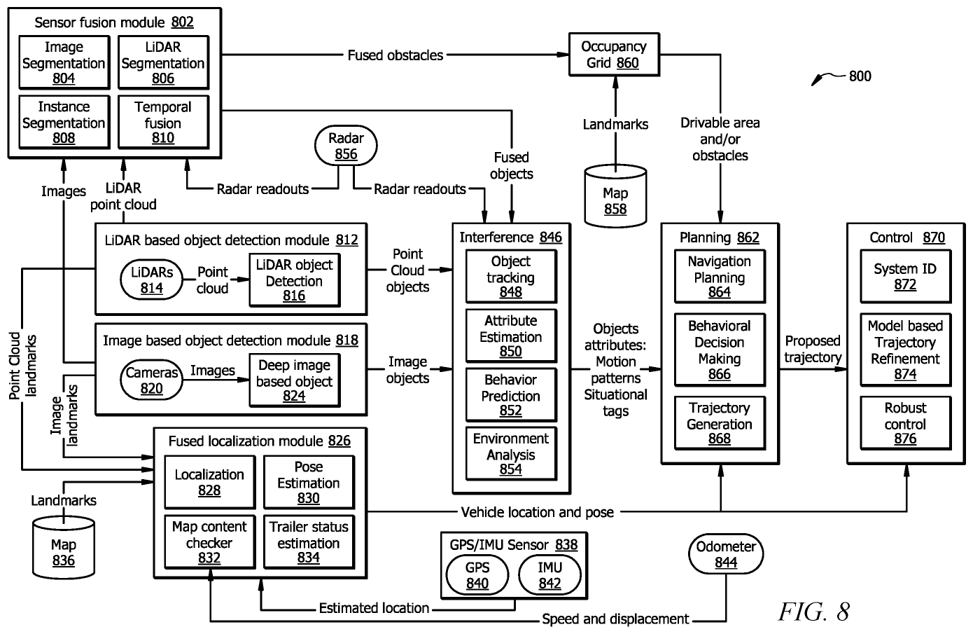

Driving instructions 136 may be implemented by the planning module 862 (See descriptions of the planning module 862 in FIG. 8.). The driving instructions 136 may include instructions and rules to adapt the autonomous driving of the autonomous vehicle 702 according to the driving rules of each stage of the routing plan 106. For example, the driving instructions 136 may include instructions to stay within the speed range of a road 102 traveled by the autonomous vehicle 702, adapt the speed of the autonomous vehicle 702 with respect to observed changes by the sensors 746, such as speeds of surrounding vehicles, objects within the detection zones of the sensors 746, as well as to adapt the velocity and/or trajectory of the autonomous vehicle based on information received from an oversight server.

Map data 138 may include a virtual map of a city or an area which includes the roads 102, 502a (see FIG. 5), and 502b (see FIG. 5). In some examples, the map data 138 may include the map 858 and map database 836 (see FIG. 8 for descriptions of the map 858 and map database 836). The map data 138 may include drivable areas, such as the road 102, paths, highways, and undrivable areas, such as terrain (determined by the occupancy grid module 860, see FIG. 8 for descriptions of the occupancy grid module 860) and areas included in the operational design domain (ODD). The map data 138 may specify locations (e.g., coordinates) of road signs, lanes, lane markings, lane boundaries, road boundaries, traffic lights, obstacles, and other items (e.g., fixtures) on or around the roadway which may influence behavior of the autonomous vehicle.

### Oversight Server

Oversight server 140 is generally configured to oversee the operations of the autonomous vehicle 702. In some embodiments, the oversight server 140 may be a component associated with and included in an oversight system. The oversight system may include components and/or subsystems configured to perform the operations of the oversight system to oversee operations of a fleet of autonomous vehicles 702. The oversight server 140 comprises a processor 142, a network interface 144, a user interface 146, and a memory 148. The components of the oversight server 140 are operably coupled to each other. The processor 142 may include one or more processing units that perform various functions as described herein. The memory 148 stores any data and/or instructions used by the processor 142 to perform its functions. For example, the memory 148 stores software instructions 150 that when executed by the processor 142 causes the oversight server 140 to perform one or more functions described herein. The oversight server 140 may be configured as shown or in any other suitable configuration.

In one embodiment, the oversight server 140 may be implemented by a cluster of computing devices that may serve to oversee the operations of the autonomous vehicle 702. For example, the oversight server 140 may be implemented by a plurality of computing devices using distributed computing and/or cloud computing systems. In another example, the oversight server 140 may be implemented by a plurality of computing devices in one or more data centers. As such, in one embodiment, the oversight server 140 may include more processing power than the control device 750. The oversight server 140 is in signal communication with the autonomous vehicle 702 and its components (e.g., the control device 750). In one embodiment, the oversight server 140 may be configured to determine a particular routing plan 106 for the autonomous vehicle 702. For example, the oversight server 140 may determine a particular routing plan 106 for an autonomous vehicle 702 that leads to reduced driving time and a safer driving experience for reaching the destination of that autonomous vehicle 702.

In one embodiment, the routing plans 106 for the autonomous vehicle 702 may be determined from Vehicle-to-Vehicle (V2V) communications, such as one autonomous vehicle 702 with another. In one embodiment, the navigating solutions or routing plans 106 for the autonomous vehicle 702 may be determined from Vehicle-to-Cloud (V2C) communications, such as the autonomous vehicle 702 with the oversight server 140.

In one embodiment, the updated routing plan 170 for the autonomous vehicle 702 may be implemented by Vehicle-to-Cloud-to-Human (V2C2H), Vehicle-to-Human (V2H), Vehicle-to-Cloud-to-Vehicle (V2C2V), Vehicle-to-Human-to-Vehicle (V2H2V), and/or Cloud-to-Cloud-to-Vehicle (C2C2V) communications, where human intervention is incorporated in determining navigating solutions for the autonomous vehicles 702. For example, a remote operator 194 may review the sensor data 130, status data 132, mission parameters 156, service 152, updated routing plan 170, and/or other data from the user interface 146 and confirm, modify, and/or override the updated routing plan 170 for the autonomous vehicle 702. The remote operator 194 may add a human perspective in determining the navigation plans of the autonomous vehicles 702 that the control device 750 and/or the oversight server 140 otherwise do not provide. In some instances, the human perspective is preferable compared to machine's perspective in terms of safety, fuel-saving, optimizing one or more mission parameters 156, etc.

In one embodiment, the updated routing plan 170 for the autonomous vehicles 702 may be implemented by any combination of V2V, V2C, V2C2H, V2H, V2C2V, V2H2V, C2C2V communications, among other types of communications.

As illustrated in FIG. 1, the remote operator 194 can access the application server 190 via communication path 192. Similarly, the remote operator 194 may access the oversight server 140 via communication path 196. In one embodiment, the oversight server 140 may send the sensor data 130, status data 132, mission parameters 156, service 152, updated routing plan 170 and/or any other data/instructions to an application server 190 to be reviewed by the remote operator 194, e.g., wirelessly through network 108 and/or via wired communication. As such, in one embodiment, the remote operator 194 can remotely access the oversight server 140 via the application server 190.

Processor 142 comprises one or more processors. The processor 142 is any electronic circuitry, including state machines, one or more central processing unit (CPU) chips, logic units, cores (e.g., a multi-core processor), field-programmable gate array (FPGAs), application-specific integrated circuits (ASICs), or digital signal processors (DSPs). The processor 142 may be a programmable logic device, a microcontroller, a microprocessor, or any suitable combination of the preceding. The processor 142 may be communicatively coupled to and in signal communication with the network interface 144, user interface 146, and memory 148. The one or more processors are configured to process data and may be implemented in hardware or software. For example, the processor 142 may be 8-bit, 16-bit, 32-bit, 64-bit or of any other suitable architecture. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 150 to implement the functions disclosed herein, such as some or all of those described with respect to FIGS. 1-6. In some embodiments, the function described herein may be implemented using logic units, FPGAs, ASICs, DSPs, or any other suitable hardware or electronic circuitry.

Network interface 144 may be configured to enable wired and/or wireless communications. The network interface 144 may be configured to communicate data between the oversight server 140 and other network devices, systems, or domain(s). For example, the network interface 144 may comprise a WIFI interface, a local area network (LAN) interface, a wide area network (WAN) interface, a modem, a switch, or a router. The processor 142 may be configured to send and receive data using the network interface 144. The network interface 144 may be configured to use any suitable type of communication protocol.

User interface 146 may include one or more user interfaces that are configured to interact with users, such as the remote operator 194. The remote operator 194 may access the oversight server 140 via the communication path 196. The user interface 146 may include peripherals of the oversight server 140, such as monitors, keyboards, mouse, trackpads, touchpads, microphones, webcams, speakers, and the like. The remote operator 194 may use the user interface 146 to access the memory 148 to review sensor data 130, status data 132, mission parameters 156, service 152, updated routing plan 170, and/or other data stored in the memory 148. The remote operator 194 may confirm, update, and/or override the updated routing plan 170.

In one embodiment, the user interface 146 may include a human-machine interface module. The human-machine interface module may be configured to display data associated with one or more autonomous vehicles 702, such as sensor data 130, status data 132, mission parameters 156, service 152, updated routing plan 170 associated with each autonomous vehicle 702, and other data stored in the memory 148. The oversight server 140 may continuously or periodically (e.g., every second, every few seconds, or any other time interval) display updates of the status of one or more autonomous vehicles 702, such as location, mission parameters 156, etc. associated with each autonomous vehicle 702 from among the one or more autonomous vehicles 702.

The human-machine interface module may be configured to indicate when any of the autonomous vehicles 702 in transit is performing a minimal risk condition maneuver 526 (see FIG. 5). The human-machine interface may be further be configured to indicate when each of the autonomous vehicles 702 in transit has completed a minimal risk condition maneuver 526 (see FIG. 5). The minimal risk condition maneuver 526 (see FIG. 5) may include pulling over onto a side of a road 102 the autonomous vehicle 702 is traveling upon, stopping abruptly in a lane of traffic in which the autonomous vehicle 702 is traveling, stopping gradually in the lane of traffic in which the autonomous vehicle 702 is traveling, among others.

Memory 148 stores any of the information described in FIGS. 1-9 along with any other data, instructions, logic, rules, or code operable to implement the function(s) described herein when executed by processor 142. For example, the memory 148 may store software instructions 150, instructions 186, a predefined rule 168, an updated routing plan 170, a down time 176, a fuel-saving parameter 188, threshold values 154, status data 132, weight values 182, mission parameters 156, services 152, a threshold down time 174, a threshold distance 178, scheduling information 114, service metadata 180, a location 184, a time window 187, weighted sums 172, service provider terminal data 189, and/or any other data/instructions. The software instructions 128 include code that when executed by the processor 142 causes the oversight server 140 to perform the functions described herein, such as some or all of those described in FIGS. 1-6. The memory 148 comprises one or more disks, tape drives, or solid-state drives, and may be used as an over-flow data storage device, to store programs when such programs are selected for execution, and to store instructions and data that are read during program execution. The memory 148 may be volatile or non-volatile and may comprise read-only memory (ROM), random-access memory (RAM), ternary content-addressable memory (TCAM), dynamic random-access memory (DRAM), and static random-access memory (SRAM). The memory 148 may include one or more of a local database, cloud database, network-attached storage (NAS), etc.

### Application Server

The application server 190 may be any computing device configured to communicate with other devices, such as other servers (e.g., oversight server 140), autonomous vehicles 702, databases, etc., via the network 108. The application server 190 may be configured to perform functions described herein and interact with the remote operator 194, e.g., via communication path 192 using its user interfaces. Examples of the application server 190 include, but are not limited to, desktop computers, laptop computers, servers, etc. In one example, the application server 190 may act as a presentation layer from which the remote operator 194 can access the oversight server 140. As such, the oversight server 140 may send the sensor data 130, status data 132, mission parameters 156, service 152, updated routing plan 170, and/or any other data/instructions to the application server 190, e.g., via the network 108. The remote operator 194, after establishing the communication path 192 with the application server 190, may review the received data and confirm, update, and/or override the updated routing plan 170, as described further below in conjunction with an operational flow of system 100.

The remote operator 194 may be an individual who is associated with and has access to the oversight server 140. For example, the remote operator 194 may be an administrator that can access and view the information regarding the autonomous vehicle 702, such as sensor data 130, status data 132, mission parameters 156, service 152, updated routing plan 170, and other information that is available on the memory 148. In one example, the remote operator 194 may access the oversight server 140 from an application server 190 that is acting as a presentation layer via the network 108.

### Operational Flow for Optimizing a Routing Plan for an Autonomous Vehicle to Receive a Service

In one embodiment, the operational flow of the system 100 begins when the oversight server 140 obtains the status data 132 from the autonomous vehicle 702. The oversight server 140 may receive the status data 132 continuously, periodically (e.g., every second, every few seconds, or any other time interval), and/or on-demand. For example, the oversight server 140 may obtain the status data 132 from the control device 750 associated with the autonomous vehicle 702. The oversight server 140 may receive the status update 132 while the autonomous vehicle 702 is in transit, e.g., traveling on the road 102. In one embodiment, the control device 750 may receive the status data 132 from one or more sensors 746. In one embodiment, the control device 750 may receive the status data 132 from the vehicle health monitoring module 123.

In some examples, the status data 132 may include health data associated with one or more components of the autonomous vehicle 702, a fuel level, an oil level, a level of a cleaning fluid used for cleaning at least one sensor 746, a cargo health, a location of the autonomous vehicle 702, a traveled distance from a start location (e.g., a launch pad), and a remaining distance to reach a destination (e.g., a landing pad). The oversight server 140 may determine the global positioning system (GPS) location of the autonomous vehicle 702 that is included in the sensor data 130 captured by the global positioning sensor 746g (see FIG. 7).

### Determining Whether the Autonomous Vehicle Needs a Service

The oversight server 140 determines whether the autonomous vehicle 702 needs a service 152 based on the status data 132. The service 152 may include fueling, cleaning one or more sensors 746, adding to a cleaning fluid used for cleaning the sensors 746, adding oil to an engine, changing oil of the engine, changing a tire, filling a tire with air, and/or any other service 152 that may be related to any component of the autonomous vehicle 702.

In some cases, the oversight server 140 may detect (e.g., from the status data 132 and/or the sensor data 130) an anomaly that would lead to determining that the autonomous vehicle 702 needs a service 152. The anomaly may include a fuel level less than a threshold value, an oil level less than a threshold value, loss of updated positioning information sent to oversight server, loss of signal between components on the autonomous vehicle, sensor readings that are anomalous for one sensor or group of sensors, trending of fuel use data to show above average consumption, and/or any other anomaly detected with respect to any component of the autonomous vehicle 702.

To determine whether the autonomous vehicle 702 needs a service 152, the oversight server 140 may compare health and/or status associated with each component of the autonomous vehicle 702 with a threshold percentage 154. The threshold percentages 154 may be associated with components that affect the mission parameters 156. For example, with respect to cleaning fluid used for cleaning the sensors 746, the oversight server 140 compares the cleaning fluid level with a first threshold percentage 154 (e.g., 30%, 20%, etc. of a predefined value). When the oversight server 140 determines that the cleaning fluid level is less than the first threshold percentage 154, the oversight server 140 determines that more cleaning fluid needs to be added.

In another example, the oversight server 140 may determine that a sensor 746 needs to be calibrated and/or cleaned based on determining that the sensor 746 has been moved (e.g., facing a different direction) and/or damaged. In another example, the oversight server 140 may determine that a sensor 746 needs to be calibrated and/or cleaned based on determining that data received from the sensor 746 does not have a quality level more than a threshold percentage. For example, the oversight server 140 may determine that a camera 746a (see FIG. 7) needs to be calibrated and/or cleaned based on determining that an image/video feed received from the camera 746a (see FIG. 7) is blurry, e.g., does not have an image quality level more than a third threshold percentage 154 (e.g., 70%, 80%, etc. of a predefined value).

In another example, with respect to fueling, when the oversight server 140 determines that a fuel level monitor of the autonomous vehicle 702 indicates that the fuel level is less than a fourth threshold percentage 154 (e.g., 40%, 30%, etc. of a predefined value) and that the remaining amount of fuel is not sufficient to reach the predetermined destination, the oversight server 140 determines that a fueling service 152 is needed.

Similarly, the oversight server 140 may compare an oil level with a threshold percentage 154, each tire pressure with a threshold percentage 154, and compare the health and/or status of other components of the autonomous vehicle 702 with a threshold percentage 154.

In some embodiments, the control device 750 may be configured to determine whether the autonomous vehicle 702 needs a service 152. In this case, the control device 750 may compare health and/or status associated with each component of the autonomous vehicle 702 with a threshold percentage 154, similar to that described above. For example, the control device 750 may determine that a sensor 746 needs to be calibrated and/or cleaned based on determining that the sensor 746 has been moved (e.g., facing a different direction) and/or damaged. In another example, the control device 750 may determine that a sensor 746 needs to be calibrated and/or cleaned based on determining that data received from the sensor 746 does not have a quality level more than a threshold percentage. For example, the control device 750 may determine that a camera 746a (see FIG. 7) needs to be calibrated and/or cleaned based on determining that an image/video feed received from the camera 746a (see FIG. 7) is blurry, e.g., does not have an image quality level more than a third threshold percentage 154 (e.g., 70%, 80%, etc. of a predefined value). In another example, with respect to fueling, when the control device 750 determines that a fuel level monitor of the autonomous vehicle 702 indicates that the fuel level is less than a fourth threshold percentage 154 (e.g., 40%, 30%, etc. of a predefined value) and that the remaining amount of fuel is not sufficient to reach the predetermined destination, the control device 750 determines that a fueling service 152 is needed. In another example, the control device 750 may compare an oil level with a threshold percentage 154, each tire pressure with a threshold percentage 154, and compare the health and/or status of other components of the autonomous vehicle 702 with a threshold percentage 154 to determine whether the autonomous vehicle 702 needs a service 152.

### Determining an Updated Routing Plan

When the oversight server 140 determines that the autonomous vehicle 702 needs a service 152, the oversight server 140 determines an updated routing plan 170 for the autonomous vehicle 702 so that the service 152 is provided to the autonomous vehicle 702.

In one embodiment, the updated routing plan 170 is determined such that a predefined rule 168 is met. The predefined rule 168 is defined to optimize one or more mission parameters 156. The one or more mission parameters 156 may comprise a route completion time 158, a fueling cost 160, a servicing cost 162, a cargo health 164, and a vehicle health 166. The route completion time 158 may represent a time duration from when the autonomous vehicle 702 starts a trip (e.g., a mission) from a start location (e.g., a launch pad) until it reaches a destination (e.g., a landing pad). The fueling cost 160 may represent a cost of fuel that the autonomous vehicle 702 uses to complete a trip that may include a cost of fuel that the autonomous vehicle would use to meet the service provider 112. The servicing cost 162 may represent a cost of a service 152 that the autonomous vehicle 702 needs to complete a trip. The cargo health 164 may represent the health of the cargo carried by the autonomous vehicle 702. The vehicle health 166 may represent the health of components of the autonomous vehicle 702.

In one embodiment, determining that a service 152 is needed for the autonomous vehicle 702 is based on one or more threshold values 154 associated with the one or more mission parameters 156. The one or more threshold values 154 may be provided by any of a client, the remote operator 194, an algorithm for optimizing fuel efficiency, an algorithm for minimizing the route completion time, and an algorithm for optimizing the one or more mission parameters 156 simultaneously. The client may be an organization or an individual who wants the autonomous vehicle 702 to transport a particular cargo from a start location to a particular destination.

In one embodiment, the oversight server 140 may determine the updated routing plan 170 so that one or more mission parameters 156 do not exceed the one or more threshold values 154.

### Determining a Level of the Service

In one embodiment, the oversight server 140 may determine a level associated with the service 152. For example, when the oversight server 140 determines that the service 152 can be provided to the autonomous vehicle 702 on a side of a road 102, the oversight server 140 determines that the service 152 is a level one service 152a. In other words, when the oversight server 140 determines that the service 152 is not a major service 152, i.e., does not require a down time 176 for the autonomous vehicle 702 more than a threshold down time 174, such as ten minutes, one hour, or any other suitable time period, the oversight server 140 determines that the service 152 is a level one service 152a.

In another example, when the oversight server 140 determines that the service 152 cannot be provided to the autonomous vehicle 702 on a side of the road 102, the oversight server 140 determines that the service 152 is a level two service 152b. In other words, when the oversight server 140 determines that the service 152 is a major service 152, i.e., requires a down time 176 for the autonomous vehicle 702 more than the threshold down time 174, the oversight server 140 determines that the service 152 is a level two service 152b. In some examples, the service 152 may have more than two levels. Thus, the oversight server 140 may determine other levels of the service 152.

Upon determining the updated routing plan 170, the oversight server 140 communicates instructions 186 that implement the updated routing plan 170 to the autonomous vehicle 702. In other words, the oversight server 140 communicated the instructions 186 to the control device 750 to instruct the autonomous vehicle 702 to implement the updated routing plan 170.

In one embodiment, the control device 750 may determine a level associated with the service 152. For example, when the control device 750 determines that the service 152 can be provided to the autonomous vehicle 702 on a side of a road 102, the control device 750 determines that the service 152 is a level one service 152a. In other words, when the control device 750 determines that the service 152 is not a major service 152, i.e., does not require a down time 176 for the autonomous vehicle 702 more than a threshold down time 174, such as ten minutes, one hour, or any other suitable time period, the control device 750 determines that the service 152 is a level one service 152a. In another example, when the control device 750 determines that the service 152 cannot be provided to the autonomous vehicle 702 on a side of the road 102, the control device 750 determines that the service 152 is a level two service 152b. In other words, when the control device 750 determines that the service 152 is a major service 152, i.e., requires a down time 176 for the autonomous vehicle 702 more than the threshold down time 174, the control device 750 determines that the service 152 is a level two service 152b. In some examples, the service 152 may have more than two levels. Thus, the control device 750 may determine other levels of the service 152. The control device 750 may communicate the determined service 152 to the oversight server 140. The oversight server 140 and/or the remote operator 194 may confirm, update, and/or override the determination of the control device 750.

### Examples of the Updated Routing Plan

In one embodiment, the updated routing plan 170 may include pulling the autonomous vehicle 702 over to a side of the road 102 in response to determining that the service 152 can be provided to the autonomous vehicle 702 on a side of the road 102. For example, when the oversight server 140 determines that the needed service 152 is a level one service 152a, the updated routing plan 170 may include pulling the autonomous vehicle 702 over to a side of the road 102.

In one embodiment, the updated routing plan 170 may include pulling the autonomous vehicle 702 over in response to determining that providing the service 152 will lead to a down time 176 that is less than the threshold down time 174.

In one embodiment, the updated routing plan 170 may include pulling over the autonomous vehicle 702 in response to determining that autonomously operating the autonomous vehicle 702 is not safe. For example, when the needed service 152 is related to autonomous function of the autonomous vehicle 702, such as sensor calibration and/or sensor cleaning, the oversight server 140 determines that operating the autonomous vehicle 702 autonomously is not safe. In another example, when the oversight server 140 determines that the autonomous vehicle 702 is no longer roadworthy such that one or more components of the autonomous vehicle 702 are malfunctioning, the oversight server 140 determines that operating the autonomous vehicle 702 autonomously is not safe.

In one embodiment, the updated routing plan 170 may include rerouting the autonomous vehicle 702 to a service provider terminal 104 (associated with a service provider 112) in response to determining that the needed service 152 cannot be provided to the autonomous vehicle 702 on a side of the road 102. For example, when the oversight server 140 determines that the needed service 152 is a level two service 152b, the updated routing plan 170 may include rerouting the autonomous vehicle 702 to a service provider terminal 104.

In one embodiment, the updated routing plan 170 may include rerouting the autonomous vehicle 702 to a service provider terminal 104 (associated with a service provider 112) in response to determining that the needed service 152 will lead to a down time 176 that is more than the threshold down time 174.

In one embodiment, the updated routing plan 170 may include the autonomous vehicle 702 returning to a start location in response to determining that a traveled distance from the start location is less than a threshold distance (e.g., less than a mile, two miles, or any other suitable distance).

Case where a Service can be Provided on a Side of the Road

In one embodiment, when the oversight server 140 determines that the needed service 152 can be provided to the autonomous vehicle 702 on a side of the road 102, the oversight server 140 may select a particular service provider 112 from among one or more service providers 112 for providing the needed service 152 to the autonomous vehicle 702 on a side of the road 102. This operation is described below.

In an example scenario, assume that the autonomous vehicle 702 is traveling along the road 102. The oversight server 140 obtains status data 132 from the control device 750, similar to that described above. From the status data 132, the oversight server 140 determines whether a service 152 needs to be provided to the autonomous vehicle 702.

When the oversight server 140 determines that the service 152 needs to be provided to the autonomous vehicle 702, the oversight server 140 determines an updated routing plan 170 for the autonomous vehicle 702 so that the service 152 is provided to the autonomous vehicle 702.

In a case where the oversight server 140 determines that the service 152 can be provided to the autonomous vehicle 702 on a side of the road 102, the oversight server 140 may select a particular service provider 112 from among one or more service providers 112 to provide the service 152 to the autonomous vehicle 702 on a side of the road 102.

In one embodiment, the oversight server 140 may select the particular service provider 112 to provide the service 152 to the autonomous vehicle 702 on a side of the road 102 such that the predefined rule 168 is met. For example, the oversight server 140 may select the particular service provider 112 to provide the service 152 to the autonomous vehicle 702 on a side of the road 102 such that it leads to optimizing one or more mission parameters 156. Mission parameters 156 may include minimization of travel time, arriving at a destination by a predetermined time, minimization of fuel costs, minimization of toll costs, minimizing number of miles traveled by the autonomous vehicle, avoidance of certain types of roadway (e.g., above a certain grade, areas under construction), avoidance of areas with known problems at certain times of day (e.g., glare that cause artifacts in sensors, icing over of the road early in the morning or late at night), or any combination thereof. To this end, the oversight server 140 may perform the operations described below.

The oversight server 140 may identify one or more service providers 112 within a threshold distance 178 from the autonomous vehicle 702, where each of the one or more service providers 112 is associated with the needed service 152. For example, the oversight server 140 may identify one or more service providers 112 that have a terminal and/or a service vehicle within threshold distance 178 of the autonomous vehicle 702.

In one embodiment, the remote operator 194 may search the Internet for the service providers 112 associated with the service 152 that are within the threshold distance 178 from the autonomous vehicle 702, and provide that to the oversight server 140.

In one embodiment, the oversight server 140 may search the Internet for service providers 112 that are associated with the service 152 that are within the threshold distance 178 from the autonomous vehicle 702, e.g., by implementing web scraping, web harvesting, or web data extraction. Alternatively, or additionally, the oversight server 140 may include a database of preselected service providers 112, such as those service providers with a location along a planned route and/or for which there is established a business relationship with the autonomous vehicle 702 and/or oversight server 140. The remote operator 194 may confirm, update, and/or override the identified service providers 112 by accessing the oversight server 140 and/or application server 190, similar to that described above.

The oversight server 140 may send service metadata 180 to the one or more identified service providers 112. For example, the oversight server 140 may send the service metadata 180 to one or more servers 110 associated with the one or more service providers 112. In a case where the oversight server 140 identified a plurality of service providers 112 within the threshold distance 178 from the autonomous vehicle 702, the oversight server 140 may send the service metadata 180 to the plurality of service providers 112 (via servers 110). For example, the oversight server 140 may send the service metadata 180 to server 110a (associated with the service provider 112a) and server 110b (associated with the service provider 112b). The service metadata 180 may include a location (e.g., a GPS location coordinate) of the autonomous vehicle 702, a type of the autonomous vehicle 702 (e.g., a tractor-trailer truck with a particular type), and the needed service 152.

The oversight server 140 may request that the one or more service providers 112 send scheduling information 114 for providing the service 152 to the autonomous vehicle 702 on a side of the road 102. For example, the oversight server 140 may send a request message to the one or more service providers 112 to send scheduling information 114 for providing the service 152 to the autonomous vehicle 702 on a side of the road 102.

The oversight server 140 may receive one or more scheduling information 114 from the one or more service providers 112 (via one or more servers 110). For example, the oversight server 140 may receive scheduling information 114a from the service provider 112a, and receive scheduling information 114b from the service provider 112b. In a case where the oversight server 140 identified a plurality of service providers 112 within the threshold distance 178 from the autonomous vehicle 702, the oversight server 140 may receive a plurality of scheduling information 114 from the plurality of service providers 112 (via a plurality of servers 110).

In one embodiment, the remote operator 194 may review the scheduling information 114 from the oversight server 140 and/or the application server 190 by accessing the oversight server 140 and/or the application server 190, similar to that described above.

Each scheduling information 114 received from each service provider 112 may include one or more location options 116, one or more time slot options 118, and a service quote 120 for providing the service 152. For example, the scheduling information 114a received from the service provider 112a may include one or more location options 116a, one or more time slot options 118a, and a service quote 120a for providing the service 152. Similarly, the scheduling information 114b received from the service provider 112b may include one or more location options 116b, one or more time slot options 118b, and a service quote 120b for providing the service 152. The service quote 120b may include a cost for each location option and/or time slot option, as well as for parts and labor to complete the service, if there is a variance.

The one or more location options 116 received from a service provider 112 may indicate location(s) that the service provider 112 is offering to provide the service 152 to the autonomous vehicle 702. The one or more time slot options 118 received from a service provider 112 may indicate time slot(s) that the service provider 112 is offering to provide the service 152 to the autonomous vehicle 702. The service quote 120 received from a service provider 112 may indicate a cost of providing the service 152. The service quote 120b may include a cost for each location option and/or time slot option, as well as for parts and labor to complete the service, if there is a variance.

The oversight server 140 may select a particular service provider 112 from among the one or more service providers 112 to provide the service 152 to the autonomous vehicle 702 based on the received scheduling information 114 such that the predefined rule 168 is met. For example, the oversight server 140 may select the particular service provider 112 such that it would lead to optimizing one or more mission parameters 156.

In this operation, the oversight server 140 may determine a weighted sum 172 of parameters, including a service down time 176, a service quote 120, a fuel-saving parameter 188 associated with each service provider 112. The oversight server 140 may select the particular service provider 112 that is associated with the highest weighted sum 172. The remote operator 194 may confirm, update, and/or override the service provider 112 selected by the oversight server 140. This operation is described below.

### Selecting a Service Provider to Provide the Service to the Autonomous Vehicle on a Side of the Road

To select a particular service provider 112 to provide the service 152 to the autonomous vehicle 702, the oversight server 140 may perform the operations below for each service provider 112. In this operation, the oversight server 140 may determine in its selection selecting which service provider 112 would lead to optimizing the mission parameters 156 and a more optimized updated routing plan 170.

The oversight server 140 may determine a service down time 176 for the autonomous vehicle 702, where the service down time 176 indicates a time period during which the service 152 is being provided by the service provider 112 to the autonomous vehicle 702. The service down time 176 may be determined based on a service duration provided by the service provider 112. The service down time 176 may have a linear relationship with the route completion time 158. When the service down time 176 is longer, the route completion time 158 is longer as well. The oversight server 140 may assign a first weight value 182 to the service down time 176 such that the first weight value 182 is inversely proportional to the service down time 176. For example, the oversight server 140 may assign a high weight value 182 to the service down time 176 (e.g., 9 out of 10, 8 out of 10, etc.), when the service down time 176 is low and/or less than a threshold down time 174 (e.g., less than ten minutes, less than fifteen minutes, etc.); and vice versa.

As described above, the oversight server 140 may receive a service quote 120 from the service provider 112 that is included in the scheduling information 114. The oversight server 140 may assign a second weight value 182 to the service quote 120 such that the second weight value 182 is inversely proportional to the service quote 120. For example, the oversight server 140 may assign a high weight value 182 to the service quote 120 (e.g., 9 out of 10, 8 out of 10, etc.) when the service quote 120 is low (e.g., less than a threshold value).

The oversight server 140 may determine an approximate amount of fuel that would be used by the autonomous vehicle 702 to meet the service provider 112 at the particular location 184 within the particular time window 187. The oversight server 140 may assign a third weight value 182 to a fuel-saving parameter 188 based on the determined approximate amount of fuel such that the third weight value 182 is proportional to the fuel-saving parameter 188. For example, the oversight server 140 may assign a high weight value 182 to the fuel-saving parameter 188 (e.g., 9 out of 10, 8 out of 10, etc.), when the determined approximate amount of fuel is low (e.g., less than a threshold amount). Similarly, the oversight server 140 may assign weight values 182 to other parameters, such as cargo health 164, vehicle health 166, a service duration, a traveling distance associated with each service provider 112. For example, with respect to traveling distance, the oversight server 140 may determine the traveling distance that the autonomous vehicle 702 would travel to meet the service provider 112 at the particular location 184 within the particular time window 187. The oversight server 140 may assign a weight value 182 to the traveling distance such that the weight value 182 is inversely proportional to the traveling distance. For example, the oversight server 140 may assign a high weight value 182 to the traveling distance if the traveling distance to the particular location 184 is less than a threshold distance.

The oversight server 140 may determine a weighted sum 172 of the service down time 176, the service quote 120, and the traveling distance. Similarly, when determining the weighted sum 172, the oversight server 140 may include the cargo health 164, the vehicle health 166, and a service duration, and fuel-saving parameter 188 assigned with weight values 182.

As described above, the oversight server 140 may perform the above operations for each service provider 112. The oversight server 140 may determine a particular service provider 112 that is associated with the highest weighted sum 172.

### Updating Autonomous Vehicle's Routing Plan to Meet the Service Provider on a Side of the Road

The oversight server 140 may determine a particular location 184 and a particular time window 187 for the autonomous vehicle 702 to meet the particular service provider 112. In this example scenario, rerouting the autonomous vehicle 702 to the particular location 184 within the particular time window 187 may be referend to as the updated routing plan 170 for the autonomous vehicle 702.

The particular location 184 and the particular time window 187 are selected based on the one or more received scheduling information 114 such that the predefined rule 168 is met. Furthermore, the particular location 184 and the particular time window 187 are selected such that one or more mission parameters 156 are optimized. For example, the oversight server 140 may consider the navigation complexity, distance that the autonomous vehicle 702 has to travel to arrive at the particular location 184 within the particular time window 187, and fuel that would be used by the autonomous vehicle 702 to arrive at the particular location 184 within the particular time window 187 such that one or more mission parameters 156 are optimized.

In this process, the oversight server 140 may select the particular location 184 from among location options 116 received from the selected particular service provider 112. Similarly, the oversight server 140 may select the particular time window 187 from among time slot options 118 received from the selected particular service provider 112.

In one embodiment, the remote operator 194 may review the selected service provider 112, the particular location 184, and the particular time window 187 from the oversight server 140 and/or the application server 190. The remote operator 194 may confirm, update, and/or override any of the selected service provider 112, the particular location 184, and the particular time window 187.

The oversight server 140 may instruct the autonomous vehicle 702 to arrive at the particular location 184 within the particular time window 187. For example, the oversight server 140 may send the instructions 186 to implement an updated routing plan 170 to the control device 750, where the updated routing plan 170 indicates to navigate the autonomous vehicle 702 to arrive at the particular location 184 within the particular time window 187.

The oversight server 140 may request the selected particular service provider 112 to meet the autonomous vehicle 702 at the particular location 184 within the particular time window 187. In one embodiment, the remote operator 194 may review the updated routing plan 170, and confirm, update, and/or override the updated routing plan 170.

In one embodiment, the oversight server 140 may conduct a transaction with the selected service provider 112 for providing the service 152 to the autonomous vehicle 702.

In this manner, the oversight server 140 may select the particular service provider 112 for providing the needed service 152 to the autonomous vehicle 702 on a side of the road 102 that would lead to optimizing one or more mission parameters 156. Further, in this manner, the oversight server 140 may select the particular location 184 and the particular time window 187 where and when the autonomous vehicle 702 would meet the selected particular service provider 112 that would lead to a more optimized updated routing plan 170.

For example, the oversight server 140 may select the particular location 184 and the particular time window 187 to meet the selected particular service provider 112 that would lead to any of: reducing navigation complexity, optimizing fuel efficiency, minimizing the route completion time 158, minimizing the fueling cost 160, minimizing the servicing cost 162, optimizing the cargo health 164, optimizing the vehicle health 166, and any combination thereof.

Case where a Service Cannot be Provided on a Side of the Road

In one embodiment, when the oversight server 140 determines that the needed service 152 cannot be provided to the autonomous vehicle 702 on a side of the road 102, the oversight server 140 may select a particular service provider 112 from among one or more service providers 112.

The oversight server 140 may instruct the autonomous vehicle 702 to drive to a particular service provider terminal 104 associated with the selected particular service provider 112 to receive the needed service 152. In this example, rerouting the autonomous vehicle 702 to the particular service terminal 104 may be referred to as an updated routing plan 170.

In an example scenario, assume that the autonomous vehicle 702 is traveling along the road 102. The oversight server 140 obtains status data 132 from the control device 750, similar to that described above. From the status data 132, the oversight server 140 determines whether a service 152 needs to be provided to the autonomous vehicle 702. When the oversight server 140 determines that the service 152 needs to be provided to the autonomous vehicle 702, the oversight server 140 determines an updated routing plan 170 for the autonomous vehicle 702 so that the service 152 is provided to the autonomous vehicle 702.

In a case where the oversight server 140 determines that the service 152 cannot be provided to the autonomous vehicle 702 on a side of the road 102, the oversight server 140 may select a particular service provider 112 from among one or more service providers 112 that is associated with a service provider terminal 104 where the autonomous vehicle 702 can receive the needed service 152. This process is described below.

The oversight server 140 may determine whether the autonomous vehicle 702 is autonomously operational to autonomously drive to the service provider terminal 104. In some cases, the oversight server 140 may determine that the autonomous vehicle 702 is autonomously operational even when the service 152 has not yet been provided to the autonomous vehicle 702. For example, the service 152 may be related to a low fuel level, a low oil level, and/or any other aspect of the autonomous vehicle 702 that does not affect the autonomous functions of the autonomous vehicle 702. In such cases, the oversight server 140 may determine that the autonomous vehicle 702 is autonomously operational while the service 152 has not been provided to the autonomous vehicle 702. In response, the oversight server 140 may instruct the autonomous vehicle 702 to drive to the terminal 104 associated with the selected service provider 112. This process is described below.

### Instructing the Autonomous Vehicle to Drive to the Selected Service Provider Terminal

The oversight server 140 may identify one or more service providers 112 within a threshold distance 178 from the autonomous vehicle 702, where each of the one or more service providers 112 is associated with the service 152. For example, the oversight server 140 may identify one or more service providers 112 that have at least one terminal 104 within the threshold distance 178 from the autonomous vehicle 702.

In one embodiment, the oversight server 140 may search the Internet for service providers 112 associated with the service 152 that are within the threshold distance 178 from the autonomous vehicle 702, e.g., by implementing web scraping. The remote operator 194 may confirm, update, and/or override the identified service providers 112.

In one embodiment, the remote operator 194 may search the Internet for the service providers 112 associated with the needed service 152 that are within the threshold distance 178 from the autonomous vehicle 702, and provide that to the oversight server 140. Alternatively, or additionally, the oversight server 140 may include a database of pre-selected service providers. The database of service providers may include service shop locations, coverage areas, costs, and response times.

The oversight server 140 may send the needed service 152 and the type of the autonomous vehicle 702 to the identified service providers 112, i.e., to servers 110 associated with the identified service providers 112. For example, the oversight server 140 may send the needed service 152 and the type of the autonomous vehicle 702 to server 110a (associated with the service provider 112a) and server 110b (associated with the service provider 112b). The oversight server 140 may request the identified service providers 112 to send service provider terminal data 189.

The oversight server 140 may receive one or more service provider terminal data 189 from the one or more identified service providers 112. In one embodiment, the remote operator 194 may review the service provider terminal data 189 from the oversight server 140 and/or the application server 190.

The service provider terminal data 189 received from a service provider 112 may include one or more of a service quote 120, a service duration, availability of parts to provide the service 152, a service agreement, and a capability of providing the service 152 to the particular type of the autonomous vehicle 702.

The oversight server 140 may select a particular service provider 112 from among the one or more service providers 112 to provide the service 152 to the autonomous vehicle 702 based on the one or more received service provider terminal data 189 such that the predefined rule 168 is met. For example, the oversight server 140 may select the particular service provider 112 such that it leads to optimizing one or more mission parameters 156, similar to that described above.

For example, the oversight server 140 may determine a weighted sum 172 of parameters, including a service down time 176, a service quote 120, a fuel-saving parameter 188 associated with each service provider 112. In response, the oversight server 140 may select the particular service provider 112 that is associated with the highest weighted sum 172. The remote operator 194 may confirm, update, and/or override the service provider 112 selected by the oversight server 140. This operation is described below.

### Selecting a Service Provider to Provide the Service to the Autonomous Vehicle in a Terminal

To select a particular service provider 112 to provide the service 152 to the autonomous vehicle 702, the oversight server 140 may perform the operations below for each service provider 112. In this operation, the oversight server 140 may determine which selection of service provider 112 would lead to optimizing the mission parameters 156 and a more optimized updated routing plan 170. To this end, the oversight server 140 may determine a weighted sum 172 of parameters, including a service down time 176, a service quote 120, and a fuel-saving parameter 188 associated with each service provider 112, similar to that described above.

In this operation, the oversight server 140 may determine a service down time 176 for the autonomous vehicle 702, where the service down time 176 may be determined based on a service duration indicated in the service provider terminal data 189. The oversight server 140 may assign a fourth weight value 182 to the service down time 176 such that the fourth weight value 182 is inversely proportional to the service down time 176, similar to that described above.

The oversight server 140 may receive a service quote 120 from the service provider 112. The oversight server 140 may assign a fifth weight value 182 to the service quote 120 such that the fifth weight value 182 is inversely proportional to the service quote 120, similar to that described above. The service quote 120 may include a cost estimate for the service provider to complete the service, including the cost of parts and labor.

The oversight server 140 may determine a traveling distance that the autonomous vehicle 702 would travel to reach the service provider terminal 104 associated with the selected service provider 112. The oversight server 140 may assign a sixth weight value 182 to the traveling distance such that the weight value 182 is inversely proportional to the traveling distance. For example, the oversight server 140 may assign a high weight value 182 to the traveling distance when the traveling distance to the particular location 184 is less than a threshold distance. Similarly, the oversight server 140 may assign weight values 182 to other parameters, such as cargo health 164, vehicle health 166, fuel-saving parameter 188, etc.

The oversight server 140 may determine a weighted sum 172 of the service down time 176, the service quote 120, and the traveling distance. Similarly, the oversight server 140 may include the cargo health 164, the vehicle health 166, and fuel-saving parameter 188 assigned with weight values 182 in determining the weighted sum 172.

As described above, the oversight server 140 may perform the above operations for each service provider 112. The oversight server 140 may determine a particular service provider 112 that is associated with the highest weighted sum 172.

### Updating Autonomous Vehicle's Routing Plan to Reroute to a Terminal

The oversight server 140 may determine a particular service provider terminal 104 associated with the selected service provider 112 that leads to optimizing one or more mission parameters 156 such that the predefined rule 168 is met. For example, the oversight server 140 may determine a particular service provider terminal 104 associated with the selected service provider 112 such that autonomous vehicle 702 driving to the particular service provider terminal 104 would lead to a more optimized updated routing plan 170 compared to other routing plans available through using another service provider terminal. In this example scenario, rerouting the autonomous vehicle 702 to the particular service provider terminal 104 may be referred to as the updated routing plan 170. In one embodiment, the remote operator 194 may review the updated routing plan 170, and confirm, update, and/or override the updated routing plan 170.

The oversight server 140 may determine a particular service provider terminal 104 associated with the selected service provider 112 such that autonomous vehicle 702 driving to the particular service provider terminal 104 would lead to any of the following: reducing navigation complexity, optimizing fuel efficiency, minimizing the route completion time 158, minimizing the fueling cost 160, minimizing the servicing cost 162, optimizing the cargo health 164, optimizing the vehicle health 166, and any combination thereof.

The oversight server 140 may instruct the autonomous vehicle 702 to drive to the particular service provider terminal 104 associated with the selected service provider 112. For example, the oversight server 140 may send the instructions 186 to the control device 750, where the instructions 186 indicate to implement the updated routing plan 170.

Case where the Autonomous Vehicle is not Autonomously Operational

As described above, when the oversight server 140 determines that the service 152 cannot be provided to the autonomous vehicle 702 on a side of the road 102 and that the autonomous vehicle 702 is autonomously operational, the oversight server may instruct the autonomous vehicle 702 to drive to a particular terminal 104 associated with a selected service provider 112.

In some cases, the service 152 may be related to the autonomous function of the autonomous vehicle 702 such that autonomously operating the autonomous vehicle 702 to a terminal 104 may not be safe (and/or the autonomous vehicle 702 may not be autonomously operational until it receives the service 152). For example, the service 152 may be related to sensor malfunction and/or other components that are involved in the autonomous navigation of the autonomous vehicle 702. In such cases, the oversight server 140 may determine that the autonomous vehicle 702 is not autonomously operational. In response, the oversight server 140 may instruct the autonomous vehicle 702 to pull over to a side of the road 102.

In one embodiment, when the oversight server 140 determines that the autonomous vehicle 702 can be driven manually (e.g., the service 152 is only related to the autonomous functions of the autonomous vehicle 702), the oversight server 140 may request a human driver to meet the autonomous vehicle 702 on a side of the road 102 and drive the autonomous vehicle 702 to a service provider terminal 104 (e.g., the terminal 104 associated with the selected service provider 112).

In one embodiment, when the oversight server 140 determines that the autonomous vehicle 702 cannot be driven manually (e.g., the service 152 is related to the autonomous and/or non-autonomous functions of the autonomous vehicle 702, such as an engine malfunction, etc.), the oversight server 140 may request a towing vehicle to tow the autonomous vehicle 702 to service provider terminal 104 (e.g., the terminal 104 associated with the selected service provider 112). In such cases, a replacement vehicle or portion of the vehicle (e.g., replacement tractor of a tractor-trailer vehicle) may also be sent to complete the transportation of cargo to its destination.

### Example Method for Optimizing a Routing Plan for an Autonomous Vehicle to Receive a Service

FIG. 2 illustrates an example flowchart of a method 200 for optimizing a routing plan of an autonomous vehicle 702 to receive a service 152. Modifications, additions, or omissions may be made to method 200. Method 200 may include more, fewer, or other operations. For example, operations may be performed in parallel or in any suitable order. While at times discussed as the autonomous vehicle 702, control device 750, oversight server 140, or components of any of thereof performing operations, any suitable system or components of the system may perform one or more operations of the method 200. For example, one or more operations of method 200 may be implemented, at least in part, in the form of software instructions 128, software instructions 150, and processing instructions 780, respectively, from FIGS. 1 and 7, stored on non-transitory, tangible, machine-readable media (e.g., memory 126, memory 148, and data storage 790, respectively, from FIGS. 1 and 7) that when run by one or more processors (e.g., processors 122, 142 and 770, respectively, from FIGS. 1 and 7) may cause the one or more processors to perform operations 202-218.

Method 200 begins at operation 202 where the oversight server 140 obtains status data 132 from an autonomous vehicle 702, while the autonomous vehicle 702 is traveling along a road 102. The oversight server 140 may obtain the status data 132 from the control device 750 associated with the autonomous vehicle 702, similar to that described in FIG. 1. In some examples, the status data 132 may include at least one of health data associated with one or more components of the autonomous vehicle 702 including any of: a fuel level, an oil level, a level of a cleaning fluid used for cleaning at least one sensor 746, a cargo health, a location of the autonomous vehicle 702, a traveled distance from a start location (e.g., a launch pad), and a remaining distance to reach a destination (e.g., a yard, a terminal, a landing pad).

At operation 204, the oversight server 140 determines whether the autonomous vehicle 702 needs a service 152 based on the status data 132. In this process, the oversight server 140 may determine whether there is an anomaly in the status data 132 that would lead to determining that the autonomous vehicle 702 needs a service 152. The anomaly may include a fuel level less than a threshold value, a fuel consumption rate greater than a projected rate, an oil level less than a threshold value, a reduction in performance (e.g., projected average speed, projected oil consumption) and/or any other anomaly detected with respect to any component of the autonomous vehicle 702. To this end, the oversight server 140 may compare the status and/or the health of different components of the autonomous vehicle 702 with a predefined threshold value 154, similar to that described in FIG. 1. Examples of the service 152 are described in FIG. 1. When the oversight server 140 determines that the autonomous vehicle 702 needs a service 152, method 200 proceeds to operation 208. Otherwise, method 200 proceeds to operation 206.

At operation 206, the oversight server 140 does not update a routing plan 106 of the autonomous vehicle 702.

At operation 208, the oversight server 140 determines whether the service 152 can be provided to the autonomous vehicle 702 on a side of the road 102. For example, the oversight server 140 determines that the service 152 can be provided to the autonomous vehicle 702 on a side of the road 102 when it is determined that a service down time 176 is less than a threshold down time 174, similar to that described in FIG. 1. When the oversight server 140 determines that the service 152 can be provided to the autonomous vehicle 702 on a side of the road 102, method 200 proceeds to 210. Otherwise, method 200 proceeds to 212.

At operation 210, the oversight server 140 determines an updated routing plan 170 so that the service 152 can be provided to the autonomous vehicle 702 on a side of the road 102, where the updated routing plan 170 comprises pulling over the autonomous vehicle 702. In this process, the oversight server 140 may select a particular service provider 112 to provide the service 152 to the autonomous vehicle 702 on a side of the road 102 such that a predefined rule 168 is met, similar to that described in FIG. 1. For example, the oversight server 140 may select a particular service provider 112 that would lead to optimizing the mission parameters 156. Further, in this process, the oversight server 140 may select a particular location 184 and a particular time window 187 where and when the autonomous vehicle 702 can pull over and meet the selected service provider 112 such that it would lead to optimizing mission parameters 156 and the updated routing plan 170, similar to that described in FIG. 1.

At operation 212, the oversight server 140 determines whether the autonomous vehicle 702 is autonomously operational. For example, when the oversight server 140 determines that the needed service 152 is related to non-autonomous functions (e.g., the needed service 152 is related to low tire pressure, low fuel level, and/or other non-autonomous functions), the oversight server 140 determines that the autonomous vehicle 702 is autonomously operational. In other words, the oversight server 140 determines that the autonomous vehicle 702 can navigate autonomously. When the oversight server 140 determines that the autonomous vehicle 702 is autonomously operational, method 200 proceeds to 216. Otherwise, method 200 proceeds to 214.

At operation 214, the oversight server 140 determines an updated routing plan 170 so that the service 152 can be provided to the autonomous vehicle 702 in a service provider terminal 104, where the updated routing plan comprises pulling over the autonomous vehicle 702 in a location where a towing vehicle tows the autonomous vehicle 702 to a service provider terminal 104. In this process, the oversight server 140 may select a particular service provider terminal 104 associated with a particular service provider 112 to provide the service 152 to the autonomous vehicle 702 such that the mission parameters 156 are optimized and the predefined rule 168 is met, similar to that described in FIG. 1.

At operation 216, the oversight server 140 determines an updated routing plan 170 so that the service 152 can be provided to the autonomous vehicle 702 in a service provider terminal 104, where the updated routing plan 170 comprises the autonomous vehicle 702 autonomously driving to the service provider terminal 104. In this process, the oversight server 140 may select a particular service provider terminal 104 associated with a particular service provider 112 to provide the service 152 to the autonomous vehicle 702 such that the mission parameters 156 are optimized and the predefined rule 168 is met, similar to that described in FIG. 1.

At operation 218, the oversight server 140 communicates instructions 186 that implement the updated routing plan 170 to the autonomous vehicle 702. The oversight server 140 may communicate the instructions 186 to the control device 750 associated with the autonomous vehicle 702.

### Example System for Granting Remote Access to an Autonomous Vehicle

FIG. 3 illustrates an embodiment of a system 300 configured for granting remote access to an autonomous vehicle 702. In one embodiment, system 300 comprises an autonomous vehicle 702 and the oversight server 140. In some embodiments, system 300 may further comprise the network 108, the application server 190 and the remote operator 194. Aspects of the network 108, autonomous vehicle 702, oversight server 140, application server 190 and remote operator 194 are described in FIGS. 1 and 2, and additional aspects are described below. Network 108 enables communications between components of the system 300. The autonomous vehicle 702 comprises the control device. The control device 750 comprises the processor 122 in signal communication with the memory 126. Memory 126 stores software instructions 340 that when executed by the processor 122 cause the control device 750 to perform one or more functions described herein. The oversight server 140 comprises the processor 142 in signal communication with the memory 148. Memory 148 stores software instructions 150 that when executed by the processor 142, cause the oversight server 140 to execute one or more functions described herein. System 300 may be configured as shown or in any other configuration.

In general, system 300 may be configured to determine whether one or more criteria 312 apply to the autonomous vehicle 702, and in response to determining that the one or more criteria 312 applies to the autonomous vehicle 702, grant remote access 320 to the autonomous vehicle 702. The one or more criteria 312 may include at least one of a geofence area 314, a particular time window 316, and a credential 318 received from a third party 302.

In one embodiment, determining whether one or more criteria 312 applies to the autonomous vehicle 702 is based on at least one of a location of the autonomous vehicle 702, a current time, and a credential 318 received from a third party 302.

In one embodiment, the criteria 312 may act as multi-factor authentication for verifying a location and time where and when a third party 302 is attempting to access the autonomous vehicle 702. For example, assume that a third party 302 wants to gain access to the autonomous vehicle 702, for example, enter a semi-truck tractor unit (i.e., a cab) of the autonomous vehicle 702, access autonomous vehicle (AV) metadata 322 associated with the autonomous vehicle 702 (e.g., health data 324 associated with one or more components of the autonomous vehicle 702, historical driving data 326, etc.), manually operate the autonomous vehicle 702, manually disable the autonomous vehicle 702 etc. In this embodiment, determining whether the criteria 312 applies to the autonomous vehicle 702 may include determining whether the autonomous vehicle 702 is within a geofence area 314, the current time is within a particular time window 316, credential 318 associated with the third party 302 is valid, and location of the third party 302 is within the geofence area 314 and within a threshold distance of the location of the autonomous vehicle 702. For example, the control device 750 may determine a distance 304 between the third party 302 and the autonomous vehicle 702 by analyzing the sensor data 328 (e.g., GPS data). The control device 750 may determine that the third party 302 is within the geofence area 314 when the distance 304 is less than a distance between the autonomous vehicle 702 and an edge of the geofence area 314.

In other words, determining whether the criteria 312 applies to the autonomous vehicle 702 may include determining whether the autonomous vehicle 702 and the third party 302 are both at a predetermined location (e.g., within the geofence area 314) within a predetermined time period (e.g., within the particular time window 316) and that the identity of the third party 302 is verified based on the credential 318 associated with the third party 302.

In some embodiments, different types and/or levels of remote access 320 to the autonomous vehicle 702 may be granted based on various situations and/or criteria 312. The various levels and/or types of remote access 320 may include allowing inbound data transmission to the autonomous vehicle (e.g., from a third party 302, oversight server 140, etc.), allowing outbound data transmission from the autonomous vehicle (e.g., to a third party 302).

The following section of this disclosure presents several example embodiments and/or situations where various criteria 312 applies to the autonomous vehicle 702, and the system 300 grants different types and/or levels of remote access 320 to the autonomous vehicle 702 based on various situations and/or criteria 312. Aspects of components of the system 300 are described initially.

### System Components

Aspects of the control device 750 are described above in FIGS. 1-2 and additional aspects are described below. The control device 750 may use the sensor data 328 to determine an obstacle-free pathway for the autonomous vehicle 702 to travel. In an example, assume that the autonomous vehicle 702 is traveling along a road. While traveling along a road, sensors 746 of the autonomous vehicle 702 capture sensor data 328. The sensor data 328 may include data regarding the environment around the autonomous vehicle 702, e.g., one or more object on and around the road. The sensors 746 transmit the sensor data 328 to the control device 750. The control device 750 processes the sensor data 328 by implementing the object detection machine learning modules 134. The control device 750 may detect objects on and around the road 502 by processing the sensor data 328. The control device 750 determines an obstacle-free pathway for the autonomous vehicle 702 to travel based on the sensor data 328. The memory 126 may be further configured to store software instructions 340 and sensor data 328.

Aspects of the oversight server 140 are described above in FIGS. 1-2, and additional aspects are described below. The memory 148 may be further configured to store software instructions 310, criteria 312, remote access 320, sensor data 328, software update package 330, and user profiles 332.

### Examples of Remote Access

In some embodiments, the remote access 320 may be defined to facilitate transmitting to and/or receiving data from one or more entities. For example, the remote access 320 may be defined to facilitate transmitting the autonomous vehicle metadata 322 to a communication device associated with the third party 302, such as a mobile phone, a smart watch, a laptop, a tablet computer, and the like. In another example, the remote access 320 may be defined to facilitate transmitting sensor data 328 and/or other data to one or more other autonomous vehicles 702.

In another example, the remote access 320 may be defined to allow a third party 302 to access autonomous vehicle metadata 322, sensor data 328, etc., for example, via the user interface 146 associated with a human-machine interface module.

In another example, the remote access 320 may be defined to allow a third party 302 to download autonomous vehicle metadata 322, sensor data 328, etc., for example, via the user interface 146 associated with a human-machine interface module.

In another example, the remote access 320 may be defined to facilitate receiving data (e.g., software update package 330) over-the-air from the oversight server 140.

In another example, the remote access 320 may be defined to allow operating one or more particular components of the autonomous vehicle 702, such as operating side windows, doors, door locks, headlights, rear view mirrors, a radio device, etc.

In another example, the remote access 320 may be defined to allow manual operation of the autonomous vehicle 702. For example, assuming that a third party 302 (e.g., a service provider) wants to manually operate the autonomous vehicle 702 to drive the autonomous vehicle 702 to a service provider terminal, remote access 320 may include unlocking a door of the cab of the autonomous vehicle and allowing manual operation of the autonomous vehicle 702 in response to verifying that the service provider has a proper driving license to operate the autonomous vehicle 702.

### Operational Flow for Granting Remote Access to an Autonomous Vehicle

In one embodiment, the operational flow of the system 300 may begin when the oversight server 140 obtains sensor data 328 from the autonomous vehicle 702. For example, the oversight server 140 may receive the sensor data 328 from the control device 750 associated with the autonomous vehicle 702. The sensor data 328 may be captured by the sensors 746, similar to that described in FIG. 1. For example, the sensor data 328 may include a location (e.g., GPS location) of the autonomous vehicle 702. In another example, the sensor data 328 may include data about the environment around the autonomous vehicle 702. For example, the sensor data 328 may include an image feed, a video feed, a point cloud feed, a radar data feed, and/or any other data feed captured by the sensors 746.

### Determining Whether One or More Criteria Apply to the Autonomous Vehicle

The oversight server 140 may determine whether one or more criteria 312 applies to the autonomous vehicle 702 based on the sensor data 328. The one or more criteria 312 may include at least one of a geofence area 314, a particular time window 316, and a credential 318 received from a third party 302.

In one embodiment, the geofence area 314 may be associated with a particular place, such as a start location (e.g., a launch pad), a destination (e.g., a landing pad), a service provider terminal (e.g., service provider terminal 104 described in FIG. 1), a weigh station, a toll booth, a law enforcement inspection site, etc. In this manner, in this embodiment, the geofence area 314 may form a boundary around the particular place. For example, the geofence area 314 may correspond to a logical fence around the particular place.

In an example scenario, assume that the geofence area 314 is associated with a start location (e.g., a launch pad). In this scenario, the autonomous vehicle 702 is preparing for departure from the start location. Thus, the oversight server 140 may determine that autonomous vehicle 702 is leaving the geofence area 314. The oversight server 140 may determine that the autonomous vehicle 702 is preparing for departure based on one or more of a command issued by the remote operator 194 and determining that the autonomous vehicle 702 has gone through a pre-trip inspection checklist. In this example, the oversight server 140 may automatically lock the doors of the autonomous vehicle 702 in response to determining that the autonomous vehicle 702 has left the geofence area 314.

In another example scenario, assume that the geofence area 314 is associated with a destination (e.g., a landing pad). Also, assume that the autonomous vehicle 702 is entering the destination. Thus, the oversight server 140 may determine that the autonomous vehicle 702 is entering the geofence area 314, e.g., based on the location of the autonomous vehicle 702. In this example, the oversight server 140 may automatically unlock the doors of the autonomous vehicle 702 in response to determining that the autonomous vehicle 702 has entered the geofence area 314. In one embodiment, the particular time window 316 may include a particular time period during a day.

In an example scenario, assume that the geofence area 314 is associated with a weigh station, that is to say that the weigh station is geofenced. When the control device 750 determines that the autonomous vehicle 702 has entered the weigh station, the control device 750 may transmit information about the autonomous vehicle 702 (e.g., the weight of the autonomous vehicle 702 and/or other information) requested from the weigh station to the weigh station, e.g., to a device associated with an operator at the weigh station from which the request originated.

In another an example scenario, assume that the geofence area 314 is associated with a weigh station. The autonomous vehicle 702 has gone through a pre-trip inspection during which the weight of the autonomous vehicle 702 is recorded in this scenario. When the control device 750 determines that the autonomous vehicle 702 has entered a geofence area 314 around the weigh station, the control device 750 may transmit information about the autonomous vehicle 702 (e.g., the weight of the autonomous vehicle 702 and/or other information) requested from the weigh station to the weigh station, similar to that described above. In this manner, the autonomous vehicle 702 may bypass the weigh station.

In one embodiment, the geofence area 314 may form a boundary with a threshold distance around the autonomous vehicle 702. The geofence area 314 may correspond to a logical fence or a logical curtain around the boundary. For example, the threshold distance may be one foot, ten feet, twenty feet, or any other suitable distance.

In one embodiment, the credential 318 may include one or more of an identification card, such as a key-card, and a biometric feature associated with the third party 302. The biometric feature associated with the third party 302 may include one or more of an image, a voice, a fingerprint, and a retinal feature associated with the third party 302.

The third party 302 may be a client who wants the autonomous vehicle 702 to transport a particular cargo, a law enforcement entity, a first responder approaching the autonomous vehicle 702 that is involved in an unexpected event (e.g., an accident), a technician at a weigh station approaching the autonomous vehicle 702 to acquire weight and/or other data from the autonomous vehicle 702, or another entity wishing access to the autonomous vehicles controls and/or data.

If the oversight server 140 determines that the one or more criteria 312 applies to the autonomous vehicle 702, the oversight server 140 may grant a third party remote access 320 to the autonomous vehicle 702.

In one embodiment, determining whether the one or more criteria 312 applies to the autonomous vehicle 702 may include determining whether the autonomous vehicle 702 is within the geofence area 314. For example, the oversight server 140 determines the location (e.g., GPS location) of the autonomous vehicle 702 from the sensor data 328. If the oversight server 140 determines that the location of the autonomous vehicle 702 is within the geofence area 314, the oversight server 140 determines that criteria 312 that indicates the geofence area 314 applies to the autonomous vehicle 702. As such, determining that the one or more criteria 312 applies to the autonomous vehicle 702 may include determining that the location of the autonomous vehicle 702 is within the geofence area 314.

In one embodiment, determining whether the one or more criteria 312 applies to the autonomous vehicle 702 may include determining whether the autonomous vehicle 702 can currently operate autonomously and whether the current time is within the particular time window 316. The oversight server 140 may determine that the autonomous vehicle 702 can currently operate autonomously if the autonomous vehicle 702 is in transit on a road, being navigated by the control device 750, and/or otherwise an engine/motor 742a (see FIG. 7) of the autonomous vehicle 702 is running. When the oversight server 140 determines that the autonomous vehicle 702 can currently operate autonomously and that the current time is within the particular time window 316, the oversight server 140 determines that criteria 312 that indicate the particular time window 316 applies to the autonomous vehicle 702.

In one embodiment, determining whether the one or more criteria 312 applies to the autonomous vehicle 702 may include determining whether the credential 318 received from a third party 302 is valid.

In an example scenario, assume that a third party 302 has approached the autonomous vehicle 702 and presented a credential 318. In one embodiment, the third party 302 may present their credential 318 to the control device 750 via the user interface 125. For example, the third party 302 may present their identification card to a camera included in the user interface 125. The third party may present a credential in the form of an RFID card, a fob, or an ID card with a bar code or QR code for scanning. In another example, the third party 302 may provide one or more of their biometric features, e.g., a fingerprint, a voice sample, a retinal sample, etc. to a fingerprint scanner, a microphone, a camera, etc. included in the user interface 125, respectively.

The control device 750 may forward the credential 318 to the oversight server 140. The oversight server 140 may determine whether the credential 318 is valid by comparing the received credential 318 with data associated with the third party 302 that may be stored in user profiles 332. The user profiles 332 may include data associated with users who have gone through a pre-registration process to be allowed remote access to the autonomous vehicle 702. For example, the oversight server 140 may search the user profiles 332 to find data that is associated with the third party 302 that matches (or corresponds) to the received credential 318. If the oversight server 140 finds data associated with the third party 302 in the user profiles 332 that matches (or corresponds) to the received credential 318, the oversight server 140 determines that the received credential 318 is valid. In one embodiment, the remote operator 194 may view the received credential 318 from the oversight server 140 and/or the application server 190. The remote operator 194 may determine whether the credential 318 is valid by searching the user profiles 332, contacting a law enforcement agency, contacting a client's server for verification, or any combination thereof. Thus, determining that the one or more criteria 312 applies to the autonomous vehicle 702 may include determining that the credential 318 is valid.

In one embodiment, determining that the criteria 312 applies to the autonomous vehicle 702 may include determining that the autonomous vehicle 702 is within the geofence area 314, determining that the autonomous vehicle 702 can currently operate autonomously and that the current time is within the particular time window 316, determining that the credential 318 is valid, and any combination thereof.

In one embodiment, the remote operator 194 may access the one or more criteria 312 from the oversight server 140 and/or the application server 190. The remote operator 194 may update, confirm, and/or override the decision of the oversight server 140 regarding whether the one or more criteria 312 applies to the autonomous vehicle 702.

### Granting Remote Access to the Autonomous Vehicle

Once the oversight server 140 and/or the remote operator 194 determine that the one or more criteria 312 applies to the autonomous vehicle 702, the oversight server 140 and/or the remote operator 194 may grant remote access 320 to the autonomous vehicle 702.

In one embodiment, the remote operator 194 may access the information and/or instructions regarding the remote access 320 from the oversight server 140 and/or the application server 190. The remote operator 194 may update, confirm, and/or override the remote access 320.

In one embodiment, the remote access 320 to the autonomous vehicle 702 may include instructing the autonomous vehicle 702 to send data to a third party 302 in response to receiving a request for the data from the third party 302. The data may include autonomous vehicle metadata 322, sensor data 328, and/or any other data associated with the autonomous vehicle 702. The sensor data 328 may include an image feed, a video feed, a point cloud data feed, and a radar data feed captured by at least one sensor 746.

In one embodiment, the remote access 320 to the autonomous vehicle 702 may include allowing an over-the-air software update. The software update may be associated with the control device 750.

In one embodiment, the remote access 320 to the autonomous vehicle 702 may include allowing manual operation of the autonomous vehicle 702, such as manually driving the autonomous vehicle 702, manually turning off the autonomous vehicle's engine, and/or manually operating one or more components of the autonomous vehicle 702, such as doors, windows, a radio device, rear view mirrors, etc.

In one embodiment, the remote access 320 to the autonomous vehicle 702 may include establishing a communication path 334 between the remote operator 194 and the control device 750. For example, the communication path 334 may be established between the control device 750 and the oversight server 140 and/or the application server 190. The remote operator 194 can access the oversight server 140 and/or the application server 190 via communication paths 196 and 192, respectively, similar to that described in FIG. 1.

In an example scenario, assume that a third party 302 has approached the autonomous vehicle 702 and presented their credential 318. In one embodiment, the third party 302 can present their credential 318 to the control device 750 via the user interface 125, similar to that described above. The control device 750 may forward the credential to the oversight server 140. If the oversight server 140 and/or the remote operator 194 determine that the credential 318 is valid, the oversight server 140 may establish the communication path 334 between the remote operator 194 and the control device 750 via the user interface 125.

In one embodiment, the communication path 334 may include a two-way communication path 334. Thus, the third party 302 and the remote operator 194 may send and receive data from each other through the communication path 334. For example, the remote operator 194 may send autonomous vehicle metadata 322, sensor data 328, and/or any other data through the communication path 334.

In one embodiment, the communication path 334 may support voice-based and/or video-based communications. Thus, the remote operator 194 and the third party 302 may converse with and see each other via a microphone and a speaker included in the user interface 125 in real-time. The video of the third party 302 may be displayed on the display screen of the user interface 146 of the oversight server 140. The video of the remote operator 194 may be displayed on a display screen of a user interface 125 of the control device 750. Alternatively, or additionally, the video and audio of the remote operator 194 may be presented to the third party via an app on a computing device (e.g., a phone, a tablet, a lap top computer, a wearable digital media device).

Although example embodiments and scenarios in FIG. 3 are described with respect to one autonomous vehicle 702, one of ordinary skill in the art would recognize other embodiments. For example, system 300 may include a fleet of autonomous vehicles 702, where each autonomous vehicle 702 from the fleet is communicatively coupled with the oversight server 140, e.g., via the network 108. The oversight server 140 may be configured to oversee operations of each autonomous vehicle 702 from the fleet. For example, the oversight server 140 may receive a set of sensor data 328 from two or more autonomous vehicles 702. The oversight server 140 may determine whether the one or more criteria 312 applies to the two or more autonomous vehicles 702 based on the set of sensor data 328, similar to that described above. The set of sensor data 328 may include two or more locations of the two or more autonomous vehicles 702, image feeds, video feeds, point cloud data feeds, and/or radar data feeds received from the two or more autonomous vehicles 702.

If the oversight server 140 determines that the one or more criteria 312 applies to the two or more autonomous vehicles 702, the oversight server 140 may grant remote access 320 to the two or more autonomous vehicles 702. In any of the operations of the oversight server 140, the remote operator 194 may confirm, update, and/or override the operation/decision of the oversight server 140.

### Example Method for Granting Remote Access to an Autonomous Vehicle

FIG. 4 illustrates an example flowchart of a method 400 for granting remote access 320 to an autonomous vehicle 702. Modifications, additions, or omissions may be made to method 400. Method 400 may include more, fewer, or other operations. For example, operations may be performed in parallel or in any suitable order. While at times discussed as the autonomous vehicle 702, control device 750, oversight server 140, or components of any of thereof performing operations, any suitable system or components of the system may perform one or more operations of the method 400. For example, one or more operations of method 400 may be implemented, at least in part, in the form of software instructions 310, software instructions 340, and processing instructions 780, respectively, from FIGS. 3 and 7, stored on non-transitory, tangible, machine-readable media (e.g., memory 126, memory 148, and data storage 790, respectively, from FIGS. 3 and 7) that when run by one or more processors (e.g., processors 122, 142, and 770, respectively, from FIGS. 3 and 7) may cause the one or more processors to perform and/or cause the execution of the operations 402-408.

Method 400 begins at operation 402 where the oversight server 140 obtains sensor data 328 from the autonomous vehicle 702. The sensor data 328 may be captured by sensors 746 associated with the autonomous vehicle 702. For example, the oversight server 140 may receive the sensor data 328 from the control device 750. The sensor data 328 may include the location (e.g., GPS location) of the autonomous vehicle 702.

At operation 404, the oversight server 140 determines whether one or more criteria 312 applies to the autonomous vehicle 702 based on the sensor data 328. The one or more criteria 312 may include at least one of a geofence area 314, a particular time window 316, and a credential 318 received from a third party 302. Examples of determining whether the one or more criteria 312 applies to the autonomous vehicle 702 are described with respect to FIG. 3. When the oversight server 140 determines that the one or more criteria 312 applies to the autonomous vehicle 702, method 400 proceeds to operation 408. Otherwise, method 400 proceeds to operation 406.

At operation 406, the oversight server 140 does not grant remote access 320 to the autonomous vehicle 702.

At operation 408, the oversight server 140 grants remote access 320 to the autonomous vehicle 702. Examples of different types and levels of the remote access 320 are described in FIG. 3. In one embodiment, the oversight server 140 may receive instructions from the remote operator 194 to grant remote access 320 to the autonomous vehicle 702. In this operation, the remote operator 194 may access and review the criteria 312 from user interface 146 of the oversight server 140 and/or user interface of the application server 190. The remote operator 194 may issue a command or instruction to the oversight server 140 to grant remote access 320 to the autonomous vehicle 702, e.g., grant remote access 320 of the autonomous vehicle 702 to a third party 302. In one embodiment, the oversight server 140 may learn from the decisions made by the remote operator 194 over time, e.g., by implementing a machine learning algorithm. Thus, operations by the oversight server 140, where the input of the remote operator 194 is involved, may be computerized.

### Example System for Implementing Periodic Mission Status Updates

FIG. 5 illustrates an embodiment of a system 500 configured for implementing periodic mission status updates for one or more autonomous vehicles 702. In one embodiment, system 500 comprises an autonomous vehicle 702 and the oversight server 140. In some embodiments, system 500 may further comprise the network 108, application server 190, remote operator 194, and a third party 508. Aspects of the network 108, autonomous vehicle 702, oversight server 140, application server 190, and remote operator 194 are described in FIGS. 1-4 and additional aspects are described below. Network 108 enables communications between components of the system 500. The autonomous vehicle 702 comprises a control device 750. The control device 750 comprises a processor 122 in signal communication with a memory 126. Memory 126 stores software instructions 540 that when executed by the processor 122 cause the control device 750 to perform one or more functions described herein. The oversight server 140 comprises the processor 142 in signal communication with the memory 148. Memory 148 stores software instructions 510 that when executed by the processor 142, cause the oversight server 140 to execute one or more functions described herein. System 500 may be configured as shown or in any other configuration.

In general, system 500 may be configured to continuously or periodically (e.g., every second, every few seconds, or any other time interval) confirm a routing plan 106 of the autonomous vehicle 702. The system 500 may implement mission status updates for the autonomous vehicle 702 and update the routing plan 106 of the autonomous vehicle 702 to optimize one or more mission parameters 156.

In one embodiment, the updated routing plan 524 may be communicated to the autonomous vehicle 702 while the autonomous vehicle 702 is in transit, e.g., is autonomously driving along a road 502. Thus, in one embodiment, the autonomous vehicle 702 may receive the updated routing plan 524 without having to pull over to a side of the road 502 (e.g., road 502a or 502b).

### System Components

Aspects of the control device 750 are described above in FIGS. 1-4 and additional aspects are described below. The control device 750 may use the sensor data 542 to determine an obstacle-free pathway for the autonomous vehicle 702 to travel. In an example, assume that the autonomous vehicle 702 is traveling along a road 502. While traveling along the road 502, sensors 746 of the autonomous vehicle 702 capture sensor data 542. The sensor data 542 may include data that describes the environment around the autonomous vehicle 702, e.g., one or more objects on and around the road 502. The sensors 746 transmit the sensor data 542 to the control device 750. The control device 750 processes the sensor data 542 by implementing the object detection machine learning modules 134. The control device 750 may detect objects on and around the road 502 by processing the sensor data 542. The control device 750 determines an obstacle-free pathway for the autonomous vehicle 702 to travel on based on the sensor data 542. The memory 126 may be further configured to store software instructions 540, sensor data 542, pre-trip inspection information 544, post-trip inspection information 550, and text messages 546.

Aspects of the oversight server 140 are described above in FIGS. 1-4 and additional aspects are described below. The memory 148 may be further configured to store map data 138, software instructions 510, road condition data 512, status data 520, sensor data 542, stopping schedule 530, routing plan 106, mission parameters 156, updated routing plan 524, safe stop maneuver 528, anomaly 522, and service 152.

### Operational Flow for Implementing Periodic Mission Status Update

In one embodiment, the operational flow of the system 500 begins when the oversight server 140 obtains road condition data 512 associated with the road 502 ahead of one or more autonomous vehicles 702.

In one embodiment, the oversight server 140 may obtain the road condition data 512 from a live news report, a live traffic report, a law enforcement report, and/or any other sources. The remote operator 194 may access the road condition data 512 from the oversight server 140 and/or the application server 190. The oversight server 140 and/or the remote operator 194 may determine whether there is an unexpected anomaly in the road condition data 512, such as a severe weather event, a traffic event, a roadblock, etc.

Although FIG. 5 describes operations of the oversight server 140 with respect to one autonomous vehicle 702, it is understood that oversight server 140 may perform a similar operation for each autonomous vehicle 702 of a fleet of autonomous vehicles 702. The corresponding description below describes example operations of the oversight server 140 to determine an updated routing plan 524 for one autonomous vehicle 702 from a fleet of autonomous vehicles 702.

The oversight server 140 may obtain status data 520 from the autonomous vehicle 702. For example, the oversight server 140 may receive the status data 520 from the control device 750 associated with the autonomous vehicle 702. The status data 520 may be captured by the vehicle health monitoring module 123, similar to that described in FIG. 1. The status data 520 may include autonomous vehicle data, a health data associated with one or more components of the autonomous vehicle 702, a location of the autonomous vehicle 702, a fuel level, an oil level, a level of a cleaning fluid used for cleaning the at least one sensor 746, a cargo status, a traveled distance from a start location (e.g., a launch pad), and a remaining distance to reach a destination (e.g., a landing pad).

Determining Whether a Routing Plan of the Autonomous Vehicle should be Changed

The oversight server 140 may determine whether a routing plan 106 of the autonomous vehicle 702 should be changed based on the road condition data 512 and/or the status data 520. The road condition data 512 may include traffic data 514, weather data 516, and law enforcement alert data 518. The traffic data 514 may include information about the traffic associated with the road 102 ahead of the autonomous vehicle 702. The weather data 516 may include information about the weather associated with the road 102 ahead of the autonomous vehicle 702. The law enforcement alert data 518 may include alerts with respect to unexpected events such as a vehicle involved in suspicious activity. Though the route is described with respect to the road ahead of the autonomous vehicle, the road condition data may pertain to highways and roadways along the route of the autonomous vehicle 702.

The oversight server 140 may determine that the routing plan 106 of the autonomous vehicle 702 should be changed in response to detecting an unexpected anomaly 522 in one or both of the road condition data 512 and the status data 520. The unexpected anomaly 522 may include one or more of a severe weather event, a traffic event, a roadblock, and a service (e.g., service 152 of FIG. 1) that needs to be provided to the autonomous vehicle 702.

For example, when the oversight server 140 determines that the autonomous vehicle 702 needs a service 152 by analyzing the status data 520, the oversight server 140 may determine that the routing plan 106 of the autonomous vehicle 702 should be changed so that the autonomous vehicle 702 can receive the service 152, similar to that described in FIGS. 1 and 2.

In another example, when the oversight server 140 determines that there is a severe weather event, a traffic event, a roadblock, or any other unexpected anomaly on the road 102 ahead of the autonomous vehicle 702, the oversight server 140 may determine that the routing plan 106 of the autonomous vehicle 702 should be changed.

The oversight server 140 may determine that the routing plan 106 of the autonomous vehicle 702 should be changed when it is determined that it is not safe for the autonomous vehicle 702 to navigate through the anomaly 522 and/or it is not within the capabilities of the autonomous vehicle 702 to navigate through the anomaly 522.

When the oversight server 140 determines that the routing plan 106 of the autonomous vehicle 702 should be changed (e.g., based on detecting an anomaly 522 in road condition data 512 and/or the status data 520), the oversight server 140 may determine the updated routing plan 524 for the autonomous vehicle 702.

In one embodiment, the remote operator 194 may access and review the status data 520 and the road condition data 512 from the oversight server 140 and/or the application server 190, e.g., via the communication path 196 and/or communication path 192, respectively. The remote operator 194 may confirm, update, and/or override the updated routing plan 524 determined by the oversight server 140. The remote operator 194 may issue a command/an instruction to the oversight server 140 to confirm, update, and/or override the updated routing plan 524. Thus, in one embodiment, determining that the routing plan 106 of the autonomous vehicle 702 should be updated may further be based on a command/an instruction received from the remote operator 194.

The oversight server 140 may communicate the updated routing plan 524 to the autonomous vehicle 702 while the autonomous vehicle 702 is autonomously driving along the road 102. The oversight server 140 may communicate the updated routing plan 524 to the autonomous vehicle 702 by transmitting the updated routing plan 524 to the control device 750 associated with the autonomous vehicle 702.

The updated routing plan 524 may include performing a minimal risk condition maneuver 526. The minimal risk condition maneuver 526 may include pulling over onto a side of a road 102 the autonomous vehicle 702 is traveling upon, stopping abruptly in a lane of traffic in which the autonomous vehicle 702 is traveling, stopping gradually in the lane of traffic in which the autonomous vehicle 702 is traveling, among others.

As discussed above, the oversight server 140 and/or the remote operator 194 may determine an updated routing plan 524 for each autonomous vehicle 702 among one or more autonomous vehicles 702. For example, the oversight server 140 may periodically (e.g., every second, every few seconds, or any other time interval) confirm the routing plan 106 of each autonomous vehicle 702 from among one or more autonomous vehicles 702.

When the oversight server 140 and/or the remote operator 194 determine that the routing plan 106 of a particular autonomous vehicle 702 from among the one or more autonomous vehicles 702 should be changed based on the road condition data 512 and/or sensor data 542 received from the particular autonomous vehicle 702, the oversight server 140 and/or the remote operator 194 may determine an updated routing plan 524 for the particular autonomous vehicle 702. In a particular example scenario, the road condition data 512 for a first autonomous vehicle 702 (e.g., a lead autonomous vehicle 702) may be applicable to a second autonomous vehicle 702 (e.g., a following autonomous vehicle 702), but not applicable to the first autonomous vehicle 702. For example, the first autonomous vehicle 702 may pass through an accident area where an accident just happened (e.g., a road accident, a car accident, and the like). In this example, the road condition data 512 may include information about the accident and the accident area, such as the type of the accident, extent of the accident, lanes occupied or unpassable due to the accident, and the like. In this example, the road condition data 512 may not be applicable to the first autonomous vehicle 702 but it may be applicable to the second autonomous vehicle 702 that is traveling toward the accident area and is following the first autonomous vehicle 702.

In one embodiment, the oversight server 140 may periodically confirm a stopping schedule 530 of each of the one or more autonomous vehicles 702. The stopping schedule 530 of an autonomous vehicle 702 may comprise time(s) and location(s) where the autonomous vehicle 702 is stopped (and will stop) to receive a service 152 from a service provider, similar to that described in FIGS. 1 and 2. The oversight server 140 may determine the updated routing plan 524 such that one or more mission parameters 156 are optimized, similar to that described in FIGS. 1 and 2. In response, the oversight server 140 may send the updated routing plan 524 to any of the one or more autonomous vehicles 702 in order to optimize the one or more mission parameters 156.

The following sections of this disclosure present example use cases where 1) the autonomous vehicle 702 encounters a toll booth 504 that is not pre-mapped in the map data 138; 2) the autonomous vehicle 702 is being prepared for a trip and a pre-trip inspection is conducted; 3) a post-trip inspection is conducted on the autonomous vehicle 702 after the trip is completed, and 4) the autonomous vehicle 702 encounters a vehicle 506 that is associated with a suspicious activity according to a law enforcement alert data 518.

Before the autonomous vehicle 702 starts its trip, the autonomous vehicle 702 may need to go through a pre-trip inspection to ensure that the autonomous vehicle 702 is roadworthy, i.e., components of the autonomous vehicle 702 are operational. In some cases, while the autonomous vehicle 702 is traveling along a road 502, the autonomous vehicle 702 may encounter an unexpected event. For example, the autonomous vehicle 702 may encounter a toll booth 504 that may not be pre-mapped in the map data 138. In another example, the autonomous vehicle 702 may encounter a vehicle 506 that is associated with a suspicious activity according to a law enforcement alert data 518. These use cases are described below.

### Case of Encountering an Unexpected Object/Obstacle on the Road

In some cases, the autonomous vehicle 702 may encounter an object or an obstacle on the road 102, such as a toll booth 504. In such cases, the oversight server 140 and/or the remote operator 194 may determine whether the autonomous vehicle 702 should transfer a particular amount of funds to the toll booth. This process is described below.

In an example scenario, assume that the autonomous vehicle 702 is traveling along the road 502a. In this scenario, there is a toll booth 504 ahead of the autonomous vehicle 702. The sensors 746 capture sensor data 542 that include objects on and around the road 502a, such as the toll booth 504. The sensors 746 send the sensor data 542 to the control device 750.

In one embodiment, the control device 750 may detect a presence of the toll booth 504 by analyzing the sensor data 542, e.g., by implementing the object detection machine learning modules 134. In one embodiment, the control device 750 may send the sensor data 542 and the result of its determination about the presence of the toll booth 504 to the oversight server 140, and the oversight server 140 and/or the remote operator 194 may confirm the presence of the toll booth 504 by analyzing the sensor data 542.

The oversight server 140 may determine whether the toll booth 504 is included in the map data 138. In this process, the oversight server 140 may compare the map data 138 that included pre-mapped obstacles, objects (e.g., road signs, buildings, terrain, lane markings, traffic lights, toll booths, etc.) on the road 502a ahead of the autonomous vehicle 702 with the received sensor data 542. If the oversight server 140 determines that the toll booth 504 is included in the map data 138, (i.e., the toll booth 504 is pre-mapped), the oversight server 140 may instruct the autonomous vehicle 702 to drive into the toll booth 504. The oversight server 140 may further instruct the autonomous vehicle 702 to transmit a particular amount of funds, or allow for funds to be transferred (e.g., present RFID payment credentials), to the toll booth 504 and continue the autonomous driving. For example, the oversight server 140 may send instructions to the control device 750 associated with the autonomous vehicle 702 to perform the operations above.

However, if the oversight server 140 determines that the toll booth 504 is not included in the map data 138 (i.e., the toll booth 504 is not pre-mapped), the oversight server 140 may instruct the autonomous vehicle 702 to perform a safe stop maneuver 528 before reaching the toll booth 504. The safe stop maneuver 528 may include pulling the autonomous vehicle 702 over into an obstacle-free spot on a side of the road 102.

The oversight server 140 may receive a confirmation, e.g., from the remote operator 194, that the toll booth 504 is newly added on the road 102.

In one embodiment, the remote operator 194 may access the sensor data 542 and the map data 138 from the oversight server 140 and/or the application server 190. Thus, the remote operator 194 may confirm that the toll booth 504 is newly added to the map data 138. In response, the remote operator 194 may issue a command/an instruction to the oversight server 140 to instruct the autonomous vehicle 702 to drive into the toll booth 504.

In response, the oversight server 140 may instruct the autonomous vehicle 702 to drive into the toll booth 504, transmit a particular amount of funds to the toll booth, and continue the autonomous driving. For example, the oversight server 140 may send instructions to the control device 750 associated with the autonomous vehicle 702 to perform the operations above.

In this manner, the oversight server 140 and/or the remote operator 194 may determine an updated navigation of the autonomous vehicle 702 based on comparing the map data 138 with received sensor data 542.

In one embodiment, the oversight server 140 may learn from the decisions made by the remote operator 194 in such situations over time, e.g., by implementing a machine learning algorithm. Thus, this process may be computerized.

In one embodiment, determining whether the toll booth 504 is pre-mapped in the map data 138 may be performed by the control device 750.

Although FIG. 5 describes an example use case of encountering a toll booth 504 on the road 502a, it is understood that the autonomous vehicle 702 may encounter any other entity on the road 102 and/or 502. For example, assume that the autonomous vehicle 702 is flagged by a law enforcement, for example, by sirens and flashing lights associated with a law enforcement vehicle. The control device 750 detects these flagging indications from sensor data 542 captured by the sensors 746. The control device 750 may instruct the autonomous vehicle 702 to pull over to a side of the road 502. A user (e.g., a law enforcement officer) may approach the autonomous vehicle 702 and request to receive data, such as health data associated with one or more components of the autonomous vehicle 702, historical driving data associated with the autonomous vehicle 702, etc. The user may present their credential 318 (see FIG. 3), similar to that described in FIG. 3. Once the credential 318 of the user is verified (e.g., by the control device 750, oversight server 140, and/or the remote operator 194), the control device 750 presents the requested data to the user, e.g., via the user interface 125, similar to that described in FIG. 3.

### Case of Conducting a Pre-Trip Inspection of the Autonomous Vehicle

Before the autonomous vehicle 702 starts its trip, the autonomous vehicle 702 may need to go through a pre-trip inspection to ensure that the autonomous vehicle 702 is roadworthy, i.e., components of the autonomous vehicle 702 are operational. In an example scenario, assume that the autonomous vehicle 702 is at a start location (e.g., at a launch pad) and is being prepared for a trip. The control device 750 receives pre-trip inspection information 544 associated with the autonomous vehicle 702. The pre-trip inspection information 544 is obtained during a pre-trip inspection of the autonomous vehicle 702. The pre-trip inspection may be associated with a physical inspection of physical components of the autonomous vehicle 702, such as components described in FIG. 7. The pre-trip inspection may further be associated with a logical inspection of autonomous functions of the autonomous vehicle 702. For example, during the pre-trip inspection, hardware and software components that are involved in navigating the autonomous vehicle 702 in the autonomous mode may be inspected.

The pre-trip inspection information 544 may be obtained by analyzing sensor data 542 captured by the sensors 746. For example, the control device 750 may implement an image processing, a video processing, a point cloud data processing, a radar data processing, and/or any other data processing algorithms to analyze the sensor data 542 and obtain the pre-trip inspection information 544.

The pre-trip inspection information 544 may be obtained from a device associated with an inspector, e.g., a technician who is inspecting the autonomous vehicle 702 during the pre-trip inspection.

For example, the inspector may inspect various components of the autonomous vehicle 702, such as vehicle drive subsystems 742 (see FIG. 7), vehicle sensor subsystems 744 (see FIG. 7), vehicle control subsystems 748 (see FIG. 7), network communication subsystem 792 (see FIG. 7), tires, and/or any other components of the autonomous vehicle 702. The inspector may inspect the various components of the autonomous vehicle 702 by a handheld device, go through a pre-trip inspection checklist, and record the status of each component of the autonomous vehicle 702.

The pre-trip inspection information 544 may include a weight of the autonomous vehicle 702, a weight distribution of a cargo carried in a trailer 704 of the autonomous vehicle 702, a fuel level, an oil level, a coolant level, a cleaning fluid level, a light functionality of headlights, functionality of sensors 746, functionality of brakes, tire pressures, functionality of subsystems of the control device 750 (see FIG. 7), and/or any other aspect of the autonomous vehicle 702.

When the control device 750 obtains the pre-trip inspection information 544, the control device 750 may supply (e.g., forward) the pre-trip inspection information 544, to an extent applicable to a third party 508. The third party 508 may include a law enforcement entity, a weigh station, a toll booth, a client who has requested the autonomous vehicle 702 to transport cargo, or any combination thereof.

In one embodiment, the control device 750 may send the sensor data 542 to the oversight server 140, and the oversight server 140 may obtain the pre-trip inspection information 544 by analyzing the sensor data 542, similar to that described above. Similarly, oversight server 140 may obtain the pre-trip inspection information 544 from a device associated with an inspector, similar to that described above. The oversight server 140 may supply (e.g., forward) the pre-trip inspection information 544 to the third party 508.

### Case of Conducting a Post-Trip Inspection of the Autonomous Vehicle

In some embodiments, similar operations conducted during a pre-trip inspection (described above) may be performed during a post-trip inspection. After the autonomous vehicle 702 finishes its trip, the autonomous vehicle 702 may need to go through a post-trip inspection to determine whether that the autonomous vehicle 702 needs service, e.g., whether the components of the autonomous vehicle 702 are operational. In an example scenario, assume that the autonomous vehicle 702 is arrived at a destination (e.g., at a landing pad) and is being inspected. The control device 750 receives post-trip inspection information 550 associated with the autonomous vehicle 702. The post-trip inspection information 550 may be obtained during a post-trip inspection of the autonomous vehicle 702. The post-trip inspection may be associated with a physical inspection of physical components of the autonomous vehicle 702, such as components described in FIG. 7. The post-trip inspection may further be associated with a logical inspection of autonomous functions of the autonomous vehicle 702. For example, during the post-trip inspection, hardware and software components that are involved in navigating the autonomous vehicle 702 in the autonomous mode may be inspected.

The post-trip inspection information 550 may be obtained by analyzing sensor data 542 captured by the sensors 746. For example, the control device 750 may implement an image processing, a video processing, a point cloud data processing, a radar data processing, and/or any other data processing algorithms to analyze the sensor data 542 and obtain the post-trip inspection information 550.

The post-trip inspection information 550 may be obtained from a device associated with an inspector, e.g., a technician who is inspecting the autonomous vehicle 702 during the post-trip inspection.

For example, the inspector may inspect various components of the autonomous vehicle 702, such as vehicle drive subsystems 742 (see FIG. 7), vehicle sensor subsystems 744 (see FIG. 7), vehicle control subsystems 748 (see FIG. 7), network communication subsystem 792 (see FIG. 7), tires, and/or any other components of the autonomous vehicle 702. The inspector may inspect the various components of the autonomous vehicle 702 by a handheld device, go through a post-trip inspection checklist, and record the status of each component of the autonomous vehicle 702.

The post-trip inspection information 550 may include a weight of the autonomous vehicle 702, a weight distribution of a cargo carried in a trailer 704 of the autonomous vehicle 702, a fuel level, an oil level, a coolant level, a cleaning fluid level, a light functionality of headlights, functionality of sensors 746, functionality of brakes, tire pressures, functionality of subsystems of the control device 750 (see FIG. 7), and/or any other aspect of the autonomous vehicle 702.

When the control device 750 obtains the post-trip inspection information 550, the control device 750 may supply (e.g., forward) the post-trip inspection information 550 to an extent applicable to a third party 508. The third party 508 may include a law enforcement entity, a weigh station, a toll booth, a client who has requested the autonomous vehicle 702 to transport cargo, or any combination thereof.

In one embodiment, the control device 750 may send the sensor data 542 to the oversight server 140, and the oversight server 140 may obtain the post-trip inspection information 550 by analyzing the sensor data 542, similar to that described above. Similarly, oversight server 140 may obtain the post-trip inspection information 550 from a device associated with an inspector, similar to that described above. The oversight server 140 may supply (e.g., forward) the post-trip inspection information 550 to the third party 508.

Case of Detecting a Vehicle Associated with a Suspicious Activity

In one embodiment, the control device 750 may receive the law enforcement alert data 518 that indicates a vehicle that is associated with a suspicious activity. For example, the control device 750 may be communicatively coupled with a communication device, such as a mobile device that is configured to receive text messages 546. A text message 546 may be associated with the law enforcement alert data 518 sent from law enforcement.

In one embodiment, the oversight server 140 may receive the law enforcement alert data 518 that indicates a vehicle that is associated with a suspicious activity. The oversight server 140 and/or the remote operator 194 may forward the law enforcement alert data 518 to one or more autonomous vehicles 702.

In an example scenario, assume that the autonomous vehicle 702 is traveling along a road 502b. The control device 750 may receive a text message 546 that includes the law enforcement alert data 518, e.g., from law enforcement and/or the oversight server 140. In one example, the law enforcement alert 548 may be associated with an amber alert.

The control device 750 may analyze the text message 546, by implementing a natural language processing (NLP) algorithm. The control device 750 may extract information about the suspected vehicle 506 from the text message 546. For example, the control device 750 may determine that the vehicle 506 is seen at a particular location by analyzing the text message 546. In another example, the control device 750 may detect a model, type, color, and/or other information about the suspected vehicle 506 that is included in the text message 546.

When the control device 750 determines that the particular location is ahead of the autonomous vehicle 702, the control device 750 may instruct the autonomous vehicle 702 to reroute to avoid the particular location.

In some embodiments, a system may include one or more components of the system 100 of FIG. 1, system 300 of FIG. 3, and system 500 of FIG. 5, and be configured to perform one or more operations of the operational flows described in FIGS. 1, 3, and 5, and one or more operations of the method 200 of FIG. 2, method 400 of FIG. 4, and method 600 of FIG. 6.

### Example Method of Implementing Periodic Mission Status Updates

FIG. 6 illustrates an example flowchart of a method 600 for implementing periodic mission status updates for an autonomous vehicle 702. Modifications, additions, or omissions may be made to method 600. Method 600 may include more, fewer, or other operations. For example, operations may be performed in parallel or in any suitable order. While at times discussed as the autonomous vehicle 702, control device 750, oversight server 140, or components of any of thereof performing operations, any suitable system or components of the system may perform one or more operations of the method 600. For example, one or more operations of the method 600 may be implemented, at least in part, in the form of software instructions 510, software instructions 540, and processing instructions 780, respectively, from FIGS. 5 and 7, stored on non-transitory, tangible, machine-readable media (e.g., memory 126, memory 148, and data storage 790, respectively, from FIGS. 5 and 7) that when run by one or more processors (e.g., processors 122, 142, and 770, respectively, from FIGS. 5 and 7) may cause the one or more processors to perform operations 602-614.

Method 600 begins at operation 602 where the oversight server 140 obtains road condition data 512. The oversight server 140 may obtain the road condition data from external sources, such as live weather reports, live traffic reports, and law enforcement reports. The road condition data 512 may include traffic data 514, weather data 516, and law enforcement alert data 518.

At operation 604, the oversight server 140 selects an autonomous vehicle 702 from among one or more autonomous vehicles 702. For example, one or more autonomous vehicles 702 may be in transit on a road 502. The oversight server 140 may iteratively select an autonomous vehicle 702 until no autonomous vehicle 702 is left for evaluation from the one or more autonomous vehicles 702.

At operation 606, the oversight server 140 obtains status data 520 from the autonomous vehicle 702. The status data 520 may include health data associated with one or more components of the autonomous vehicle 702, cargo health, a location of the autonomous vehicle 702, a fuel level, an oil level, a level of a cleaning fluid used for cleaning the at least one sensor 746, a cargo status, a traveled distance from a start location (e.g., a launch pad), and a remaining distance to reach a destination (e.g., a landing pad).

At operation 608, the oversight server 140 determines whether a routing plan 106 of the autonomous vehicle 702 should be updated based on the road condition data 512 and the status data 520. For example, when the oversight server 140 detects an unexpected anomaly 522 in road condition data 512 and/or status data 520, the oversight server 140 may determine that the routing plan 106 of the autonomous vehicle 702 should be updated. When the oversight server 140 determines that the routing plan 106 of the autonomous vehicle 702 should be updated, method 600 proceeds to operation 612. Otherwise, method 600 proceed to operation 610.

At operation 610, the oversight server 140 does not update the routing plan 106 of the autonomous vehicle 702.

At operation 612, the oversight server 140 communicates an updated routing plan 524 to the autonomous vehicle 702 while the autonomous vehicle 702 is autonomously driving along a road.

At operation 614, the oversight server 140 determines whether to select another autonomous vehicle 702. When at least one autonomous vehicle 702 is left for evaluation, the oversight server 140 determines to select another autonomous vehicle 702. When the oversight server 140 determines to select another autonomous vehicle 702, method 600 returns to operation 604. Otherwise, method 600 terminates.

### Example Autonomous Vehicle and its Operation

FIG. 7 shows a block diagram of an example vehicle ecosystem 700 in which autonomous driving operations can be determined. As shown in FIG. 7, the autonomous vehicle 702 may be a semi-trailer truck. The vehicle ecosystem 700 may include several systems and components that can generate and/or deliver one or more sources of information/data and related services to the in-vehicle control computer 750 that may be located in an autonomous vehicle 702. The in-vehicle control computer 750 can be in data communication with a plurality of vehicle subsystems 740, all of which can be resident in the autonomous vehicle 702. A vehicle subsystem interface 760 may be provided to facilitate data communication between the in-vehicle control computer 750 and the plurality of vehicle subsystems 740. In some embodiments, the vehicle subsystem interface 760 can include a controller area network (CAN) controller to communicate with devices in the vehicle subsystems 740.

The autonomous vehicle 702 may include various vehicle subsystems that support the operation of autonomous vehicle 702. The vehicle subsystems 740 may include a vehicle drive subsystems 742, a vehicle sensor subsystems 744, a vehicle control subsystems 748, and/or network communication subsystem 792. The components or devices of the vehicle drive subsystems 742, the vehicle sensor subsystems 744, and the vehicle control subsystems 748 shown in FIG. 7 are examples. The autonomous vehicle 702 may be configured as shown or according to any other configurations.

The vehicle drive subsystems 742 may include components operable to provide powered motion for the autonomous vehicle 702. In an example embodiment, the vehicle drive subsystems 742 may include an engine/motor 742a, wheels/tires 742b, a transmission 742c, an electrical subsystem 742d, and a power source 742e.

The vehicle sensor subsystems 744 may include a number of sensors 746 configured to sense information about an environment or condition of the autonomous vehicle 702. The vehicle sensor subsystems 744 may include one or more cameras 746a or image capture devices, a radar unit 746b, one or more temperature sensors 746c, a wireless communication unit 746d (e.g., a cellular communication transceiver), an inertial measurement unit (IMU) 746e, a laser range finder/LiDAR unit 746f, a Global Positioning System (GPS) transceiver 746g, and/or a wiper control system 746h. The vehicle sensor subsystems 744 may also include sensors configured to monitor internal systems of the autonomous vehicle 702 (e.g., an 02 monitor, a fuel gauge, an engine oil temperature, etc.).

The IMU 746e may include any combination of sensors (e.g., accelerometers and gyroscopes) configured to sense position and orientation changes of the autonomous vehicle 702 based on inertial acceleration. The GPS transceiver 746g may be any sensor configured to estimate a geographic location of the autonomous vehicle 702. For this purpose, the GPS transceiver 746g may include a receiver/transmitter operable to provide information regarding the position of the autonomous vehicle 702 with respect to the Earth. The radar unit 746b may represent a system that utilizes radio signals to sense objects within the local environment of the autonomous vehicle 702. In some embodiments, in addition to sensing the objects, the radar unit 746b may additionally be configured to sense the speed and the heading of the objects proximate to the autonomous vehicle 702. The laser range finder or LiDAR unit 746f may be any sensor configured to use lasers to sense objects in the environment in which the autonomous vehicle 702 is located. The cameras 746a may include one or more devices configured to capture a plurality of images of the environment of the autonomous vehicle 702. The cameras 746a may be still-image cameras or motion-video cameras.

The vehicle control subsystems 748 may be configured to control the operation of the autonomous vehicle 702 and its components. Accordingly, the vehicle control subsystems 748 may include various elements such as a throttle and gear selector 748a, a brake unit 748b, a navigation unit 748c, a steering system 748d, and/or an autonomous control unit 748e. The throttle and gear selector 748a may be configured to control, for instance, the operating speed of the engine and, in turn, control the speed of the autonomous vehicle 702. The throttle and gear selector 748a may be configured to control the gear selection of the transmission. The brake unit 748b can include any combination of mechanisms configured to decelerate the autonomous vehicle 702. The brake unit 748b can slow the autonomous vehicle 702 in a standard manner, including by using friction to slow the wheels or engine braking. The brake unit 748b may include an anti-lock brake system (ABS) that can prevent the brakes from locking up when the brakes are applied. The navigation unit 748c may be any system configured to determine a driving path or route for the autonomous vehicle 702. The navigation unit 748c may additionally be configured to update the driving path dynamically while the autonomous vehicle 702 is in operation. In some embodiments, the navigation unit 748c may be configured to incorporate data from the GPS transceiver 746g and one or more predetermined maps so as to determine the driving path for the autonomous vehicle 702. The steering system 748d may represent any combination of mechanisms that may be operable to adjust the heading of autonomous vehicle 702 in an autonomous mode or in a driver-controlled mode.

The autonomous control unit 748e may represent a control system configured to identify, evaluate, and avoid or otherwise negotiate potential obstacles or obstructions in the environment of the autonomous vehicle 702. In general, the autonomous control unit 748e may be configured to control the autonomous vehicle 702 for operation without a driver or to provide driver assistance in controlling the autonomous vehicle 702. In some embodiments, the autonomous control unit 748e may be configured to incorporate data from the GPS transceiver 746g, the radar unit 746b, the LiDAR unit 746f, the cameras 746a, and/or other vehicle subsystems to determine the driving path or trajectory for the autonomous vehicle 702.

The network communication subsystem 792 may comprise network interfaces, such as routers, switches, modems, and/or the like. The network communication subsystem 792 may be configured to establish communication between the autonomous vehicle 702 and other systems including the oversight server 140 of FIGS. 1-6. The network communication subsystem 792 may be further configured to send and receive data from and to other systems.

Many or all of the functions of the autonomous vehicle 702 can be controlled by the in-vehicle control computer 750. The in-vehicle control computer 750 may include at least one data processor 770 (which can include at least one microprocessor) that executes processing instructions 780 stored in a non-transitory computer-readable medium, such as the data storage device 790 or memory. The in-vehicle control computer 750 may also represent a plurality of computing devices that may serve to control individual components or subsystems of the autonomous vehicle 702 in a distributed fashion. In some embodiments, the data storage device 790 may contain processing instructions 780 (e.g., program logic) executable by the data processor 770 to perform various methods and/or functions of the autonomous vehicle 702, including those described with respect to FIGS. 1-9.

The data storage device 790 may contain additional instructions as well, including instructions to transmit data to, receive data from, interact with, or control one or more of the vehicle drive subsystems 742, the vehicle sensor subsystems 744, and the vehicle control subsystems 748. The in-vehicle control computer 750 can be configured to include a data processor 770 and a data storage device 790. The in-vehicle control computer 750 may control the function of the autonomous vehicle 702 based on inputs received from various vehicle subsystems (e.g., the vehicle drive subsystems 742, the vehicle sensor subsystems 744, and the vehicle control subsystems 748).

FIG. 8 shows an exemplary system 800 for providing precise autonomous driving operations. The system 800 may include several modules that can operate in the in-vehicle control computer 750, as described in FIG. 7. The in-vehicle control computer 750 may include a sensor fusion module 802 shown in the top left corner of FIG. 8, where the sensor fusion module 802 may perform at least four image or signal processing operations. The sensor fusion module 802 can obtain images from cameras located on an autonomous vehicle to perform image segmentation 804 to detect the presence of moving objects (e.g., other vehicles, pedestrians, etc.,) and/or static obstacles (e.g., stop sign, speed bump, terrain, etc.,) located around the autonomous vehicle. The sensor fusion module 802 can obtain LiDAR point cloud data item from LiDAR sensors located on the autonomous vehicle to perform LiDAR segmentation 806 to detect the presence of objects and/or obstacles located around the autonomous vehicle.

The sensor fusion module 802 can perform instance segmentation 808 on image and/or point cloud data items to identify an outline (e.g., boxes) around the objects and/or obstacles located around the autonomous vehicle. The sensor fusion module 802 can perform temporal fusion 810 where objects and/or obstacles from one image and/or one frame of point cloud data item are correlated with or associated with objects and/or obstacles from one or more images or frames subsequently received in time.

The sensor fusion module 802 can fuse the objects and/or obstacles from the images obtained from the camera and/or point cloud data item obtained from the LiDAR sensors. For example, the sensor fusion module 802 may determine based on a location of two cameras that an image from one of the cameras comprising one half of a vehicle located in front of the autonomous vehicle is the same as the vehicle captured by another camera. The sensor fusion module 802 may send the fused object information to the interference module 846 and the fused obstacle information to the occupancy grid module 860. The in-vehicle control computer may include the occupancy grid module 860 which can retrieve landmarks from a map database 858 stored in the in-vehicle control computer. The occupancy grid module 860 can determine drivable areas and/or obstacles from the fused obstacles obtained from the sensor fusion module 802 and the landmarks stored in the map database 858. For example, the occupancy grid module 860 can determine that a drivable area may include a speed bump obstacle.

Below the sensor fusion module 802, the in-vehicle control computer 750 may include a LiDAR-based object detection module 812 that can perform object detection 816 based on point cloud data item obtained from the LiDAR sensors 814 located on the autonomous vehicle. The object detection 816 technique can provide a location (e.g., in 3D world coordinates) of objects from the point cloud data item. Below the LiDAR-based object detection module 812, the in-vehicle control computer 750 may include an image-based object detection module 818 that can perform object detection 824 based on images obtained from cameras 820 located on the autonomous vehicle. The object detection 818 technique can employ a deep machine learning technique 824 to provide a location (e.g., in 3D world coordinates) of objects from the image provided by the camera 820.

The radar 856 on the autonomous vehicle can scan an area in front of the autonomous vehicle or an area towards which the autonomous vehicle is driven. The radar data may be sent to the sensor fusion module 802 that can use the radar data to correlate the objects and/or obstacles detected by the radar 856 with the objects and/or obstacles detected from both the LiDAR point cloud data item and the camera image. The radar data also may be sent to the interference module 846 that can perform data processing on the radar data to track objects by object tracking module 848 as further described below.

The in-vehicle control computer 750 may include an interference module 846 that receives the locations of the objects from the point cloud and the objects from the image, and the fused objects from the sensor fusion module 802. The interference module 846 also receives the radar data with which the interference module 846 can track objects by object tracking module 848 from one point cloud data item and one image obtained at one time instance to another (or the next) point cloud data item and another image obtained at another subsequent time instance.

The interference module 846 may perform object attribute estimation 850 to estimate one or more attributes of an object detected in an image or point cloud data item. The one or more attributes of the object may include a type of object (e.g., pedestrian, car, or truck, etc.). The interference module 846 may perform behavior prediction 852 to estimate or predict motion pattern of an object detected in an image and/or a point cloud. The behavior prediction 852 can be performed to detect a location of an object in a set of images received at different points in time (e.g., sequential images) or in a set of point cloud data item received at different points in time (e.g., sequential point cloud data items). In some embodiments, the behavior prediction 852 can be performed for each image received from a camera and/or each point cloud data item received from the LiDAR sensor. In some embodiments, the interference module 846 can be performed (e.g., run or executed) to reduce computational load by performing behavior prediction 852 on every other or after every pre-determined number of images received from a camera or point cloud data item received from the LiDAR sensor (e.g., after every two images or after every three-point cloud data items).

The behavior prediction 852 feature may determine the speed and direction of the objects that surround the autonomous vehicle from the radar data, where the speed and direction information can be used to predict or determine motion patterns of objects. A motion pattern may comprise a predicted trajectory information of an object over a pre-determined length of time in the future after an image is received from a camera. Based on the motion pattern predicted, the interference module 846 may assign motion pattern situational tags to the objects (e.g., “located at coordinates (x,y),” “stopped,” “driving at 50 mph,” “speeding up” or “slowing down”). The situation tags can describe the motion pattern of the object. The interference module 846 may send the one or more object attributes (e.g., types of the objects) and motion pattern situational tags to the planning module 862. The interference module 846 may perform an environment analysis 854 using any information acquired by system 800 and any number and combination of its components.

The in-vehicle control computer 750 may include the planning module 862 that receives the object attributes and motion pattern situational tags from the interference module 846, the drivable area and/or obstacles, and the vehicle location and pose information from the fused localization module 826 (further described below).

The planning module 862 can perform navigation planning 864 to determine a set of trajectories on which the autonomous vehicle can be driven. The set of trajectories can be determined based on the drivable area information, the one or more object attributes of objects, the motion pattern situational tags of the objects, location of the obstacles, and the drivable area information. In some embodiments, the navigation planning 864 may include determining an area next to the road where the autonomous vehicle can be safely parked in case of emergencies. The planning module 862 may include behavioral decision making 866 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 862 performs trajectory generation 868 and selects a trajectory from the set of trajectories determined by the navigation planning operation 864. The selected trajectory information may be sent by the planning module 862 to the control module 870.

The in-vehicle control computer 750 may include a control module 870 that receives the proposed trajectory from the planning module 862 and the autonomous vehicle location and pose from the fused localization module 826. The control module 870 may include a system identifier 872. The control module 870 can perform a model-based trajectory refinement 874 to refine the proposed trajectory. For example, the control module 870 can apply filtering (e.g., Kalman filter) to make the proposed trajectory data smooth and/or to minimize noise. The control module 870 may perform the robust control 876 by determining, based on the refined proposed trajectory information and current location and/or pose of the autonomous vehicle, an amount of brake pressure to apply, a steering angle, a throttle amount to control the speed of the vehicle, and/or a transmission gear. The control module 870 can send the determined brake pressure, steering angle, throttle amount, and/or transmission gear to one or more devices in the autonomous vehicle to control and facilitate precise driving operations of the autonomous vehicle.

The deep image-based object detection 824 performed by the image-based object detection module 818 can also be used detect landmarks (e.g., stop signs, speed bumps, etc.,) on the road. The in-vehicle control computer may include a fused localization module 826 that obtains landmarks detected from images, the landmarks obtained from a map database 836 stored on the in-vehicle control computer 750, the landmarks detected from the point cloud data item by the LiDAR-based object detection module 812, the speed and displacement from the odometer sensor 844 and the estimated location of the autonomous vehicle from the GPS/IMU sensor 838 (i.e., GPS sensor 840 and IMU sensor 842) located on or in the autonomous vehicle. Based on this information, the fused localization module 826 can perform a localization operation 828 to determine a location of the autonomous vehicle, which can be sent to the planning module 862 and the control module 870.

The fused localization module 826 can estimate pose 830 of the autonomous vehicle based on the GPS and/or IMU sensors 838. The pose of the autonomous vehicle can be sent to the planning module 862 and the control module 870. The fused localization module 826 can also estimate status (e.g., location, possible angle of movement) of the trailer unit based on (e.g., trailer status estimation 834), for example, the information provided by the IMU sensor 842 (e.g., angular rate and/or linear velocity). The fused localization module 826 may also check the map content 832.

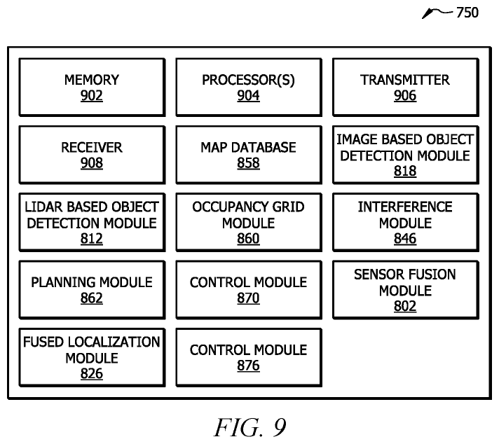

FIG. 9 shows an exemplary block diagram of an in-vehicle control computer 750 included in an autonomous vehicle 702. The in-vehicle control computer 750 may include at least one processor 904 and a memory 902 having instructions stored thereupon (e.g., software instructions 128, 340, 540, and processing instructions 780 in FIGS. 1, 3, 5, and 7, respectively). The instructions, upon execution by the processor 904, configure the in-vehicle control computer 750 and/or the various modules of the in-vehicle control computer 750 to perform the operations described in FIGS. 1-9. The transmitter 906 may transmit or send information or data to one or more devices in the autonomous vehicle. For example, the transmitter 906 can send an instruction to one or more motors of the steering wheel to steer the autonomous vehicle. The receiver 908 receives information or data transmitted or sent by one or more devices. For example, the receiver 908 receives a status of the current speed from the odometer sensor or the current transmission gear from the transmission. The transmitter 906 and receiver 908 also may be configured to communicate with the plurality of vehicle subsystems 740 and the in-vehicle control computer 750 described above in FIGS. 7 and 8.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated into another system or some features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.

Clause 1. A system comprising:

an autonomous vehicle configured to travel along a road according to a routing plan, wherein the autonomous vehicle comprises at least one sensor; and

an oversight server, communicatively coupled with the autonomous vehicle, and comprising a processor configured to:
obtain status data captured by the at least one sensor;
determine that a service is needed for the autonomous vehicle based at least in part upon the status data;
determine an updated routing plan so that the service is provided to the autonomous vehicle; and
communicate instructions that implement the updated routing plan to the autonomous vehicle.

Clause 2. The system of Clause 1, wherein the status data comprises at least one of health data associated with one or more components of the autonomous vehicle, a fuel level, an oil level, a level of a cleaning fluid used for cleaning the at least one sensor, a location of the autonomous vehicle, a traveled distance from a start location, and a remaining distance to reach a destination.

Clause 3. The system of Clause 1, wherein:

the updated routing plan is determined such that a predefined rule is met; and

the predefined rule is defined to optimize one or more mission parameters comprising a route completion time, a fueling cost, a servicing cost, a cargo health, and an autonomous vehicle health.

Clause 4. The system of Clause 3, wherein determining that the service is needed is further based at least in part upon one or more threshold values for the one or more mission parameters provided by any of a client, an operator, an algorithm for optimizing fuel efficiency, an algorithm for minimizing the route completion time, and an algorithm for optimizing the one or more mission parameters simultaneously.

Clause 5. The system of Clause 1, wherein the processor is further configured to determine a level associated with the service, such that:

in response to determining that the service can be provided to the autonomous vehicle on a side of the road, the service is a level one service; and

in response to determining that the service cannot be provided to the autonomous vehicle on the side of the road, the service is a level two service.

Clause 6. The system of Clause 1, wherein the updated routing plan comprises pulling the autonomous vehicle over in response to determining that the service can be provided to the autonomous vehicle on a side of the road.

Clause 7. The system of Clause 1, wherein the updated routing plan comprises pulling the autonomous vehicle over in response to determining that providing the service will lead to a first down time that is less than a threshold down time.

Clause 8. A method comprising:

obtaining status data captured by at least one sensor associated with an autonomous vehicle;

determining that a service is needed for the autonomous vehicle based at least in part upon the status data;

determining an updated routing plan so that the service is provided to the autonomous vehicle; and

communicating instructions that implement the updated routing plan to the autonomous vehicle.

Clause 9. The method of Clause 8, wherein the updated routing plan comprises pulling the autonomous vehicle over in response to determining that autonomously operating the autonomous vehicle is not safe.

Clause 10. The method of Clause 8, wherein the updated routing plan comprises rerouting the autonomous vehicle to a service provider terminal in response to determining that the service cannot be provided to the autonomous vehicle on a side of a road.

Clause 11. The method of Clause 8, further comprising:

determining that the service can be provided to the autonomous vehicle on a side of a road;

identifying one or more first service providers within a threshold distance from the autonomous vehicle, wherein each of the one or more first service providers are associated with the service;

sending service metadata to the one or more first service providers, wherein the service metadata comprises a location of the autonomous vehicle, a type of the autonomous vehicle, and the needed service;

requesting the one or more first service providers to send scheduling information for providing the service to the autonomous vehicle, wherein the scheduling information comprises at least one of a service quote, a service duration; one or more location options, and one or more time slot options;

receiving one or more scheduling information from the one or more first service providers;

selecting a first service provider from among the one or more first service providers to provide the service to the autonomous vehicle based at least in part upon the one or more scheduling information such that a predefined rule is met, wherein the predefined rule is defined to optimize one or more mission parameters comprising a route completion time, a fueling cost, a servicing cost, a cargo health, and a vehicle health;

determining a particular location and a particular time window for the autonomous vehicle to meet the first service provider based at least in part upon the one or more scheduling information such that the predefined rule is met;

instructing the autonomous vehicle to arrive at the particular location within the particular time window; and

requesting the first service provider to meet the autonomous vehicle at the particular location within the particular time window.

Clause 12. The method of Clause 11, wherein selecting the first service provider from among the one or more first service providers to provide the service to the autonomous vehicle based at least in part upon the one or more scheduling information such that the predefined rule is met comprises:

for each service provider from among the one or more first service providers:
determining a service down time for the autonomous vehicle while the service is being provided by the service provider;
assigning a first weight value to the service down time such that the first weight value is inversely proportional to the service down time;
receiving the service quote from the service provider;
assigning a second weight value to the service quote such that the second weight value is inversely proportional to the service quote;
determining an approximate amount of fuel that would be used by the autonomous vehicle to meet the first service provider at the particular location within the particular time window;
assigning a third weight value to a fuel saving parameter based at least in part upon the approximate amount of fuel such that the third weight value is proportional to the fuel saving parameter; and
determining a weighted sum of the service down time, the service quote, and the fuel saving parameter; and

determining that the first service provider is associated with the highest weighted sum.

Clause 13. The method of Clause 11, wherein:

the particular location is selected from among the one or more location options received from the first service provider;

the particular time window is selected from among the one or more time slot options received from the first service provider; and

the particular location and the particular time window are selected such that the predefined rule is met.

Clause 14. A non-transitory computer-readable medium storing instructions that when executed by one or more processors cause the one or more processors to:

obtain status data captured by at least one sensor associated with an autonomous vehicle;

determine that a service is needed for the autonomous vehicle based at least in part upon the status data;

determine an updated routing plan so that the service is provided to the autonomous vehicle; and

communicate instructions that implement the updated routing plan to the autonomous vehicle.

Clause 15. The non-transitory computer-readable medium of Clause 14, wherein the updated routing plan comprises rerouting the autonomous vehicle to a service provider terminal in response to determining that providing the service will lead to a second down time for the autonomous vehicle that is more than a threshold down time.

Clause 16. The non-transitory computer-readable medium of Clause 14, wherein the updated routing plan comprises the autonomous vehicle returning to a start location in response to determining that a traveled distance from the start location is less than a threshold distance.

Clause 17. The non-transitory computer-readable medium of Clause 14, wherein the instructions when executed by the one or more processors, further cause the one or more processors to:

determine that the service cannot be provided to the autonomous vehicle on a side of a road;

determine that the autonomous vehicle is autonomously operational;

in response to determining that the autonomous vehicle is autonomously operational:
identify one or more second service providers within a threshold distance from the autonomous vehicle, wherein each of the one or more second service providers is associated with the service;
send the needed service and a type of the autonomous vehicle to the one or more second service providers;
request the one or more second service providers to send service provider terminal data;
receive one or more service provider terminal data from the one or more second service providers;
select a second service provider from among the one or more second service providers to provide the service to the autonomous vehicle based at least in part upon the one or more service provider terminal data such that a predefined rule is met, wherein the predefined rule is defined to optimize one or more mission parameters comprising a route completion time, a fueling cost, a servicing cost, a cargo health, and a vehicle health; and
instruct the autonomous vehicle to drive to a particular service provider terminal associated with the second service provider.

Clause 18. The non-transitory computer-readable medium of Clause 17, wherein selecting the second service provider from among the one or more second service providers to provide the service to the autonomous vehicle based at least in part upon the one or more service provider terminal data such that the predefined rule is met comprises:

for each service provider from among the one or more second service providers:
determining a service down time for the autonomous vehicle while the service is being provided by the service provider;
assigning a fourth weight value to the service down time such that the fourth weight value is inversely proportional to the service down time;
receiving a service quote from the service provider;
assigning a fifth weight value to the service quote such that the fifth weight value is inversely proportional to the service quote;
determining a traveling distance that the autonomous vehicle would travel to reach the second service provider;
assigning a sixth weight value to the traveling distance such that the sixth weight value is inversely proportional to the traveling distance; and
determining a weighted sum of the service down time, the service quote, and the traveling distance; and

determining that the second service provider is associated with the highest weighted sum.

Clause 19. The non-transitory computer-readable medium of Clause 17, wherein the instructions when executed by the one or more processors, further cause the one or more processors in response to determining that the autonomous vehicle is not autonomously operational to:

instruct the autonomous vehicle to pull over; and

request a towing vehicle to tow the autonomous vehicle to the second service provider.

Clause 20. The non-transitory computer-readable medium of Clause 17, wherein the service provider terminal data comprises one or more of a service quote, a service duration, an availability of parts to provide the service, and a capability of providing the service to the autonomous vehicle.

Clause 21. A system comprising:

an autonomous vehicle comprising at least one sensor configured to capture a first sensor data; and

an oversight server, communicatively coupled with the autonomous vehicle, and comprising a processor configured to:
obtain the first sensor data from the autonomous vehicle;
determine that one or more criteria apply to the autonomous vehicle based at least in part upon the first sensor data, wherein:
   the one or more criteria comprise at least one of a geofence area, a particular time window, and a credential received from a third party; and
   determining that the one or more criteria apply to the autonomous vehicle is based at least in part upon at least one of a location of the autonomous vehicle, a current time, and the credential received from the third party; and
in response to determining that the one or more criteria apply to the autonomous vehicle, grant remote access to the autonomous vehicle.

Clause 22. The system of Clause 21, wherein the first sensor data comprises the location of the autonomous vehicle.

Clause 23. The system of Clause 21, wherein:

the geofence area forms a boundary around a particular place comprising a service terminal, a weigh station, a launch pad, or a landing pad; and

determining that the one or more criteria apply to the autonomous vehicle comprises determining that the location of the autonomous vehicle is within the geofence area.

Clause 24. The system of Clause 21, wherein determining that the one or more criteria apply to the autonomous vehicle comprises determining that the autonomous vehicle can currently operate autonomously and that the current time is within the particular time window.

Clause 25. The system of Clause 21, wherein determining that the one or more criteria apply to the autonomous vehicle comprises determining that the credential is valid.

Clause 26. The system of Clause 25, wherein:

the credential comprises one or more of an identification card and a biometric feature associated with the third party; and

the biometric feature comprises one or more of an image, a voice, a fingerprint, and a retinal feature associated with the third party.

Clause 27. The system of Clause 21, wherein the remote access to the autonomous vehicle comprises unlocking a door of the autonomous vehicle.

Clause 28. A method comprising:

obtaining first sensor data captured from at least one sensor associated with an autonomous vehicle;

determining that one or more criteria apply to the autonomous vehicle based at least in part upon the first sensor data, wherein:
the one or more criteria comprise at least one of a geofence area, a particular time window, and a credential received from a third party; and
determining that the one or more criteria apply to the autonomous vehicle is based at least in part upon at least one of a location of the autonomous vehicle, a current time, and the credential received from the third party; and

in response to determining that the one or more criteria apply to the autonomous vehicle, granting remote access to the autonomous vehicle.

Clause 29. The method of Clause 28, wherein:

the one or more criteria comprise: the geofence area, the particular time window, and the credential received from the third party; and

determining that the one or more criteria apply to the autonomous vehicle comprises:
determining that the autonomous vehicle is within the geofence area;
determining that the autonomous vehicle can currently operate autonomously and that the current time is within the particular time window; and
determining that the credential is valid.

Clause 30. The method of Clause 28, wherein the remote access to the autonomous vehicle comprises instructing the autonomous vehicle to send data to a third party in response to receiving a request to obtain the data from the third party.

Clause 31. The method of Clause 30, wherein the data comprises one or more of health data associated with one or more components of the autonomous vehicle, historical driving data, and a particular sensor data.

Clause 32. The method of Clause 31, wherein the particular sensor data comprises one or more of an image feed, a video feed, a point-cloud data feed, and a radar-data feed captured by the at least one sensor associated with the autonomous vehicle.

Clause 33. The method of Clause 28, wherein the at least one sensor comprises at least one of a camera, a light detection and ranging sensor, an infrared sensor, and a radar.

Clause 34. The method of Clause 28, wherein the remote access to the autonomous vehicle comprises allowing an over-the-air software update.

Clause 35. A non-transitory computer-readable medium storing instructions that when executed by one or more processors cause the one or more processors to:

obtain first sensor data from an autonomous vehicle;

determine that one or more criteria apply to the autonomous vehicle based at least in part upon the first sensor data, wherein:
the one or more criteria comprise at least one of a geofence area, a particular time window, and a credential received from a third party; and
determining that the one or more criteria apply to the autonomous vehicle is based at least in part upon at least one of a location of the autonomous vehicle, a current time, and the credential received from the third party; and

in response to determining that the one or more criteria apply to the autonomous vehicle, grant remote access to the autonomous vehicle.

Clause 36. The non-transitory computer-readable medium of Clause 25, wherein the remote access to the autonomous vehicle comprises allowing manual operation of the autonomous vehicle.

Clause 37. The non-transitory computer-readable medium of Clause 25, wherein the remote access to the autonomous vehicle comprises establishing a communication path between a remote operator and a control device associated with the autonomous vehicle.

Clause 38. The non-transitory computer-readable medium of Clause 27, wherein:

the communication path comprises a two-way communication path; and

the communication path supports one or more of a voice-based communication and a video-based communication.

Clause 39. The non-transitory computer-readable medium of Clause 25, wherein the instructions when executed by the one or more processors, further cause the one or more processors to:

obtain a second sensor data from two or more autonomous vehicles from among a fleet of autonomous vehicles;

determine that the one or more criteria apply to the two or more autonomous vehicles based at least in part upon the second sensor data; and

grant remote access to the two or more autonomous vehicles.

Clause 40. The non-transitory computer-readable medium of Clause 29, wherein the second sensor data comprises two or more locations of the two or more autonomous vehicles.

Clause 41. A system comprising:

one or more autonomous vehicles configured to travel along a road, wherein each of the one or more autonomous vehicles comprises at least one sensor; and

an oversight server, communicatively coupled with the one or more autonomous vehicles, comprising a processor configured to:
obtain road condition data associated with the road ahead of the one or more autonomous vehicles;
for an autonomous vehicle from among the one or more autonomous vehicles:
   obtain status data from the autonomous vehicle;
   determine that a routing plan associated with the autonomous vehicle should be updated based at least in part upon one or both of the road condition data and the status data, wherein:
      determining that the routing plan should be updated is in response to detecting an unexpected anomaly in one or both of the road condition data and the status data that leads to diverting from the routing plan; and
      the unexpected anomaly comprises one or more of: a severe weather event; a traffic event; a roadblock; and a service that needs to be provided to the autonomous vehicle; and
   communicate the updated routing plan to the autonomous vehicle while the autonomous vehicle is autonomously driving along the road.

Clause 42. The system of Clause 41, wherein the processor is further configured to:

periodically confirm the routing plan of each of the one or more autonomous vehicles;

periodically confirm a stopping schedule of each of the one or more autonomous vehicles, wherein the stopping schedule associated with a particular autonomous vehicle comprises a time and a location where the particular autonomous vehicle is stopped to receive the service from a service provider; and

optimize one or more mission parameters comprising a route time completion, a fueling cost, a servicing cost, a cargo health, and a vehicle health.

Clause 43. The system of Clause 42, wherein the processor is further configured to send the updated routing plan to any of the one or more autonomous vehicles in order to optimize the one or more mission parameters.

Clause 44. The system of Clause 41, wherein the road condition data comprises at least one of a weather data, a traffic data, and law enforcement alert data.

Clause 45. The system of Clause 41, wherein:

the status data is captured from the at least one sensor; and

the at least one sensor comprises at least one of a camera, a light detection and ranging sensor, an infrared sensor, and a radar.

Clause 46. The system of Clause 41, wherein the status data comprises at least one of a health data associated with one or more components of the autonomous vehicle, a location of the autonomous vehicle, a fuel level, an oil level, a level of a cleaning fluid used for cleaning the at least one sensor, a cargo status, a traveled distance from a start location, and a remaining distance to reach a destination.

Clause 47. The system of Clause 41, wherein determining that the routing plan associated with the autonomous vehicle should be updated is further based at least in part upon an instruction received from a remote operator.

Clause 48. A method comprising:

obtaining road condition data associated with a road ahead of one or more autonomous vehicles;

for an autonomous vehicle from among the one or more autonomous vehicles:
obtaining status data from at least one sensor associated with the autonomous vehicle;
determining that a routing plan associated with the autonomous vehicle should be updated based at least in part upon one or both of the road condition data and the status data, wherein:
   determining that the routing plan should be updated is in response to detecting an unexpected anomaly in one or both of the road condition data and the status data that leads to diverting from the routing plan; and
   the unexpected anomaly comprises one or more of: a severe weather event; a traffic event; a roadblock; and a service that needs to be provided to the autonomous vehicle; and
communicating the updated routing plan to the autonomous vehicle while the autonomous vehicle is autonomously driving along the road.

Clause 49. The method of Clause 48, wherein the road condition data is obtained from at least one of a live news report, a live traffic report, and a law enforcement report.

Clause 50. The method of Clause 48, wherein the updated routing plan comprises performing a minimal risk maneuver.

Clause 51. The method of Clause 50, wherein the minimal risk maneuver comprises:

pulling over onto a side of the road the autonomous vehicle is traveling upon;

stopping abruptly in a lane of traffic in which the autonomous vehicle is traveling; or stopping gradually in the lane of traffic in which the autonomous vehicle is traveling.

Clause 52. The method of Clause 48, further comprising:

detecting, from sensor data captured by at the least one sensor associated with the autonomous vehicle, a presence of a toll booth ahead of the autonomous vehicle;

determining whether the toll booth is included in a map data;

in response to determining that the toll booth is included in the map data:
instructing the autonomous vehicle to drive into the toll booth;
instructing the autonomous vehicle to transmit a first particular amount of funds to the toll booth; and
instructing the autonomous vehicle to continue an autonomous driving.

Clause 53. The method of Clause 52, further comprising in response to determining that the toll booth is not included in the map data:

instructing the autonomous vehicle to perform a safe stop maneuver before reaching the toll booth;

receiving a confirmation that the toll booth is newly added on the road;

instructing the autonomous vehicle to drive into the toll booth;

instructing the autonomous vehicle to transmit a second particular amount of funds to the toll booth; and

instructing the autonomous vehicle to continue the autonomous driving.

Clause 54. The method of Clause 53, wherein the safe stop maneuver comprises pulling the autonomous vehicle over into an obstacle-free spot on a side of a road.

Clause 55. A non-transitory computer-readable medium storing instructions that when executed by one or more processors cause the one or more processors to:

obtain road condition data associated with a road ahead of one or more autonomous vehicles;

for an autonomous vehicle from among the one or more autonomous vehicles:
obtain status data from at least one sensor associated with the autonomous vehicle;
determine that a routing plan associated with the autonomous vehicle should be updated based at least in part upon one or both of the road condition data and the status data, wherein:
   determining that the routing plan should be updated is in response to detecting an unexpected anomaly in one or both of the road condition data and the status data that leads to diverting from the routing plan; and
   the unexpected anomaly comprises one or more of: a severe weather event; a traffic event; a roadblock; and a service that needs to be provided to the autonomous vehicle; and
communicate the updated routing plan to the autonomous vehicle while the autonomous vehicle is autonomously driving along the road.

Clause 56. The non-transitory computer-readable medium of Clause 55, wherein the instructions when executed by the one or more processors, further cause the one or more processors to:

receive pre-trip inspection information associated with the autonomous vehicle, wherein:
the pre-trip inspection information is obtained during a pre-trip inspection of the autonomous vehicle; and
the pre-trip inspection information is associated with at least one of a physical inspection of physical components of the autonomous vehicle and a logical inspection of autonomous functions of the autonomous vehicle; and

supply the pre-trip inspection information to a third party, wherein the third party comprises a law enforcement entity, a client, or any combination thereof.

Clause 57. The non-transitory computer-readable medium of Clause 56, wherein the pre-trip inspection information is obtained by analyzing sensor data captured by the at least one sensor.

Clause 58. The non-transitory computer-readable medium of Clause 56, wherein the pre-trip inspection information is obtained from a device associated with an inspector.

Clause 59. The non-transitory computer-readable medium of Clause 56, wherein the pre-trip inspection information comprises one or more of:

a weight of the autonomous vehicle;

a weight distribution of a cargo carried by the autonomous vehicle;

a fuel level;

an oil level;

a coolant level;

a cleaning fluid level;

a light functionality of headlights;

a sensor functionality;

a brake functionality; or

tire pressures.

Clause 60. The non-transitory computer-readable medium of Clause 56, wherein the instructions when executed by the one or more processors, further cause the one or more processors to:

receive a text message that comprises a law enforcement alert, wherein the law enforcement alert indicates a vehicle that is associated with a suspicious act is seen at a particular location;

determine that the particular location is ahead of the autonomous vehicle; and

instruct the autonomous vehicle to reroute to avoid the particular location.

Clause 61. The system of any of Clauses 1-7, wherein the processor is further configured to perform one or more operations of a method according to any of Clauses 8-13.

Clause 62. The system of any of Clauses 1-7, wherein the processor is further configured to perform one or more operations according to any of Clauses 14-20.

Clause 63. An apparatus comprising means for performing a method according to any of Clauses 8-13.

Clause 64. An apparatus comprising means for performing one or more instructions according to any of Clauses 14-20.

Clause 65. The non-transitory computer-readable medium of any of Clauses 14-20 storing instructions that when executed by the one or more processors further cause the one or more processors to perform one or more operations of a method according to any of Clauses 8-13 when performed on a system.

Clause 66. The system of any of Clauses 21-27, wherein the processor is further configured to perform one or more operations of a method according to any of Clauses 28-34.

Clause 67. The system of any of Clauses 21-27, wherein the processor is further configured to perform one or more operations according to any of Clauses 35-40.

Clause 68. An apparatus comprising means for performing a method according to any of Clauses 28-34.

Clause 69. An apparatus comprising means for performing one or more instructions according to any of Clauses 35-40.

Clause 70. The non-transitory computer-readable medium of any of Clauses 35-40 storing instructions that when executed by the one or more processors further cause the one or more processors to perform one or more operations of a method according to any of Clauses 28-34 when performed on a system.

Clause 71. The system of any of Clauses 41-47, wherein the processor is further configured to perform one or more operations of a method according to any of Clauses 48-54.

Clause 72. The system of any of Clauses 41-47, wherein the processor is further configured to perform one or more operations according to any of Clauses 55-60.

Clause 73. An apparatus comprising means for performing a method according to any of Clauses 48-54.

Clause 74. An apparatus comprising means for performing one or more instructions according to any of Clauses 55-60.

Clause 75. The non-transitory computer-readable medium of any of Clauses 55-60 storing instructions that when executed by the one or more processors further cause the one or more processors to perform one or more operations of a method according to any of Clauses 48-54 when performed on a system.

Clause 76. An apparatus comprising means for performing one or more operations of a method according to any of Clauses 8-13, 28-34, or 48-54 when performed on a system.

Clause 77. A system according to any of Clauses 1-7, 21-27, or 41-47.

Clause 78. A method comprising operations according to any of Clauses 8-13, 28-34, or 48-54.

Clause 79. A non-transitory computer-readable medium storing instructions that when executed by one or more processors cause the one or more processors to perform one or more operations according to any of Clauses 14-20, 35-40, or 55-60.

1. A system comprising:
an autonomous vehicle configured to travel along a road according to a routing plan, wherein the autonomous vehicle comprises at least one sensor; and
an oversight server, communicatively coupled with the autonomous vehicle, and comprising a processor configured to:
obtain status data captured by the at least one sensor;
determine that a service is needed for the autonomous vehicle based at least in part upon the status data;
determine an updated routing plan so that the service is provided to the autonomous vehicle; and
communicate instructions that implement the updated routing plan to the autonomous vehicle.

2. The system of claim 1, wherein the status data comprises at least one of health data associated with one or more components of the autonomous vehicle, a fuel level, an oil level, a level of a cleaning fluid used for cleaning the at least one sensor, a location of the autonomous vehicle, a traveled distance from a start location, and a remaining distance to reach a destination.

3. The system of claim 1, wherein:
the updated routing plan is determined such that a predefined rule is met; and
the predefined rule is defined to optimize one or more mission parameters comprising a route completion time, a fueling cost, a servicing cost, a cargo health, and an autonomous vehicle health.

4. The system of claim 3, wherein determining that the service is needed is further based at least in part upon one or more threshold values for the one or more mission parameters provided by any of a client, an operator, an algorithm for optimizing fuel efficiency, an algorithm for minimizing the route completion time, and an algorithm for optimizing the one or more mission parameters simultaneously.

5. The system of claim 1, wherein the processor is further configured to determine a level associated with the service, such that:
in response to determining that the service can be provided to the autonomous vehicle on a side of the road, the service is a level one service; and
in response to determining that the service cannot be provided to the autonomous vehicle on the side of the road, the service is a level two service.

6. The system of claim 1, wherein the updated routing plan comprises pulling the autonomous vehicle over in response to determining that the service can be provided to the autonomous vehicle on a side of the road.

7. The system of claim 1, wherein the updated routing plan comprises pulling the autonomous vehicle over in response to determining that providing the service will lead to a first down time that is less than a threshold down time.

8. A method comprising:
obtaining status data captured by at least one sensor associated with an autonomous vehicle;
determining that a service is needed for the autonomous vehicle based at least in part upon the status data;
determining an updated routing plan so that the service is provided to the autonomous vehicle; and
communicating instructions that implement the updated routing plan to the autonomous vehicle.

9. The method of claim 8, wherein the updated routing plan comprises pulling the autonomous vehicle over in response to determining that autonomously operating the autonomous vehicle is not safe.

10. The method of claim 8, wherein the updated routing plan comprises rerouting the autonomous vehicle to a service provider terminal in response to determining that the service cannot be provided to the autonomous vehicle on a side of a road.

11. The method of claim 8, further comprising:
determining that the service can be provided to the autonomous vehicle on a side of a road;
identifying one or more first service providers within a threshold distance from the autonomous vehicle, wherein each of the one or more first service providers are associated with the service;
sending service metadata to the one or more first service providers, wherein the service metadata comprises a location of the autonomous vehicle, a type of the autonomous vehicle, and the needed service;
requesting the one or more first service providers to send scheduling information for providing the service to the autonomous vehicle, wherein the scheduling information comprises at least one of a service quote, a service duration; one or more location options, and one or more time slot options;
receiving one or more scheduling information from the one or more first service providers;
selecting a first service provider from among the one or more first service providers to provide the service to the autonomous vehicle based at least in part upon the one or more scheduling information such that a predefined rule is met, wherein the predefined rule is defined to optimize one or more mission parameters comprising a route completion time, a fueling cost, a servicing cost, a cargo health, and a vehicle health;
determining a particular location and a particular time window for the autonomous vehicle to meet the first service provider based at least in part upon the one or more scheduling information such that the predefined rule is met;
instructing the autonomous vehicle to arrive at the particular location within the particular time window; and
requesting the first service provider to meet the autonomous vehicle at the particular location within the particular time window.

12. The method of claim 11, wherein selecting the first service provider from among the one or more first service providers to provide the service to the autonomous vehicle based at least in part upon the one or more scheduling information such that the predefined rule is met comprises:
for each service provider from among the one or more first service providers:
determining a service down time for the autonomous vehicle while the service is being provided by the service provider;
assigning a first weight value to the service down time such that the first weight value is inversely proportional to the service down time;
receiving the service quote from the service provider;
assigning a second weight value to the service quote such that the second weight value is inversely proportional to the service quote;
determining an approximate amount of fuel that would be used by the autonomous vehicle to meet the first service provider at the particular location within the particular time window;
assigning a third weight value to a fuel saving parameter based at least in part upon the approximate amount of fuel such that the third weight value is proportional to the fuel saving parameter; and
determining a weighted sum of the service down time, the service quote, and the fuel saving parameter; and
determining that the first service provider is associated with the highest weighted sum.

13. The method of claim 11, wherein:
the particular location is selected from among the one or more location options received from the first service provider;
the particular time window is selected from among the one or more time slot options received from the first service provider; and
the particular location and the particular time window are selected such that the predefined rule is met.

14. A non-transitory computer-readable medium storing instructions that when executed by one or more processors cause the one or more processors to:
obtain status data captured by at least one sensor associated with an autonomous vehicle;
determine that a service is needed for the autonomous vehicle based at least in part upon the status data;
determine an updated routing plan so that the service is provided to the autonomous vehicle; and
communicate instructions that implement the updated routing plan to the autonomous vehicle.

15. The non-transitory computer-readable medium of claim 14, wherein the updated routing plan comprises rerouting the autonomous vehicle to a service provider terminal in response to determining that providing the service will lead to a second down time for the autonomous vehicle that is more than a threshold down time.

16. The non-transitory computer-readable medium of claim 14, wherein the updated routing plan comprises the autonomous vehicle returning to a start location in response to determining that a traveled distance from the start location is less than a threshold distance.

17. The non-transitory computer-readable medium of claim 14, wherein the instructions when executed by the one or more processors, further cause the one or more processors to:
determine that the service cannot be provided to the autonomous vehicle on a side of a road;
determine that the autonomous vehicle is autonomously operational;
in response to determining that the autonomous vehicle is autonomously operational:
identify one or more second service providers within a threshold distance from the autonomous vehicle, wherein each of the one or more second service providers is associated with the service;
send the needed service and a type of the autonomous vehicle to the one or more second service providers;
request the one or more second service providers to send service provider terminal data;
receive one or more service provider terminal data from the one or more second service providers;
select a second service provider from among the one or more second service providers to provide the service to the autonomous vehicle based at least in part upon the one or more service provider terminal data such that a predefined rule is met, wherein the predefined rule is defined to optimize one or more mission parameters comprising a route completion time, a fueling cost, a servicing cost, a cargo health, and a vehicle health; and
instruct the autonomous vehicle to drive to a particular service provider terminal associated with the second service provider.

18. The non-transitory computer-readable medium of claim 17, wherein selecting the second service provider from among the one or more second service providers to provide the service to the autonomous vehicle based at least in part upon the one or more service provider terminal data such that the predefined rule is met comprises:
for each service provider from among the one or more second service providers:
determining a service down time for the autonomous vehicle while the service is being provided by the service provider;
assigning a fourth weight value to the service down time such that the fourth weight value is inversely proportional to the service down time;
receiving a service quote from the service provider;
assigning a fifth weight value to the service quote such that the fifth weight value is inversely proportional to the service quote;
determining a traveling distance that the autonomous vehicle would travel to reach the second service provider;
assigning a sixth weight value to the traveling distance such that the sixth weight value is inversely proportional to the traveling distance; and
determining a weighted sum of the service down time, the service quote, and the traveling distance; and
determining that the second service provider is associated with the highest weighted sum.

19. The non-transitory computer-readable medium of claim 17, wherein the instructions when executed by the one or more processors, further cause the one or more processors in response to determining that the autonomous vehicle is not autonomously operational to:
instruct the autonomous vehicle to pull over; and
request a towing vehicle to tow the autonomous vehicle to the second service provider.

20. The non-transitory computer-readable medium of claim 17, wherein the service provider terminal data comprises one or more of a service quote, a service duration, an availability of parts to provide the service, and a capability of providing the service to the autonomous vehicle.
